(19) United States
(12) Patent Application Publication
(10) Pub. No.: US 2004/0199575 A1
(43) Pub. Date: Oct. 7, 2004

(54) E-commerce enabling virtual streaming multimedia server, system, method and article

(75) Inventor: Barry Ira Geller, Sunland, CA (US)

Correspondence Address: McDermott, Will & Emery, 600 13th Street, N.W., Washington, DC, 20005-3096, US

(73) Assignee: EXTREMING, INC., Studio City, CA

(21) Appl. No.: 10/828,349

(22) Filed: Apr. 21, 2004

Related U.S. Application Data
(63) Continuation of application No. 09/639,364, filed on Aug. 15, 2000, now abandoned.

(51) Int. Cl. G06F 17/60

(52) U.S. Cl. 709/201; 705/1; 703/23

(57) ABSTRACT

Buying items through electronic commerce via the Internet has achieved widespread popularity. Items can typically be purchased over the Internet with, considerably less effort than purchasing them using conventional means. Electronic commerce is far from ideal though in that delays may be encountered in the transferring of data that is necessary to facilitate the electronics buying experience. An E-merchant's computer may be inadequate, or overburdened by a heavy shopping load and consequently data transfer speed can suffer to the point where buyer actually abandon the partially completed purchase order. To solve these problems, a Brand Blaster (BB) method of commerce is introduced which locates the functionality of E-Commerce website to a user's PC because the entire E-Commerce experience is located on user's computer. Any delays are minimized and the shopping experience is enhanced. Additionally new functions can be considered because previous delays inherent in E-Commerce transactions are greatly reduced or eliminated.

### FIELD OF THE INVENTION

The present invention relates to systems, methods and articles for Electronic Commerce (E-Commerce) and Direct Marketing and, in particular embodiments to providing improved E-Commerce and Direct Marketing through the use of a Virtual Streaming Multimedia Server (VSMS).

### BACKGROUND OF THE INVENTION

A typical E-Commerce experience will commonly involve a user who has a computer system equipped with a monitor, a graphics card, a sound card and a connection to the Internet, for example, through a modem. The modem will commonly be used to connect the user's computer via the telephone line to an E-Commerce web site on the Internet.

A user who desires to purchase, lease or otherwise obtain a particular item may employ such a computer system to access a website that provides such items for sale, lease or otherwise. In order to determine which sites provide the desired type of items, the user may employ a search engine and search for the items. A user may also know from experience, advertising, word-of-mouth or a variety of other sources, one or more sites that carry the particular item that the user is seeking.

Alternatively the individual may surf the Internet and, by chance, happen upon an item he or she wishes to purchase. This type of buying is commonly termed impulse buying. Impulse buying on the Internet commonly occurs quickly, often in as little as one second, with the click of a mouse. If the impulse purchase is not concluded quickly, the impulse may pass and the sale may be lost.

If the user is searching for a particular item and has found an appropriate site, the user may access the site and then proceed to attempt to locate the desired item. The amount of time that is necessary to find the item to be purchased depends on a variety of factors. The amount of time that it takes to find the desired item is critically important because surveys have shown that, the longer that it takes to find the item to be purchased, the more likely that the user will not complete the purchase. Once the desired item is found, however, the user may fail to complete a purchase for a variety of reasons. One reason that an individual may fail to complete the purchase is that they may become discouraged by the amount of time required to complete the transaction, even after finding the item. Generally the time to complete a transaction depends directly on the speed at which an individual can navigate through the website at which the purchase is to be made. The speed of navigation of an E-Commerce website depends on a variety of factors.

Before a user may attempt to purchase a desired item on a particular website, the user must find the link on the website home page that allows the user to “go shopping.” In addition, once the user has found the link that allows the user to go shopping, the user may be required to select from a series of different categories of products which can be found on that particular website. Adding to the delay of navigating to the correct web page is the delay that is encountered in displaying a particular web page, finding what is pertinent on the page, and then selecting a further web page that is then sent to the user by a server computer. Some web pages are highly complex containing involved graphics, animation files, accompanying sound, video streaming or the like. Such web pages may contain hundreds of kilobytes or even megabytes of data which must be delivered to the user's computer in order to properly display the web page or the user's video selection. The speed with which the data comprising a web page can be delivered to a user also depends on the speed at which the web server is able to stream data to the user. The speed at which the web server is able to stream data to a user may, in turn, be dependant on how many users are simultaneously accessing the website, which can be in the 10's of thousands or even millions, and how many are currently being served by the web server. The speed of delivery of data also depends on how fast the connection is between the web server and the user's computer as well as the capabilities and configuration of the user's machine. The speed of delivery of the data can also be impacted by the time of day, because the traffic on the Internet tends to vary at different times.

A further delay that is encountered, once the user has located the particular item to be purchased, is the process of “checking out.” Checking out may involve the delivery of several different checkout pages and forms to the user as well as several data interchanges between the user's system and the E-Commerce web server. Some surveys show that more than half of the users who start to purchase a product on-line do not end up actually purchasing the product because of site slowdown. Additionally, during peak periods it has been found there may be 100% packet loss of at least one segment of network connection streams due to packets being dropped at Internet connection points.

E-Commerce can provide an order of magnitude improvement in speed over the common brick and mortar type of commerce. To purchase an item using a typical brick and mortar type of commerce a buyer must physically travel (for example, drive) to a location, such as a mall, which sells the desired type of item. The buyer must then park and enter the store. After entering the store the buyer must locate the item desired. While shopping, the buyer may also buy other items on impulse. The likelihood that a buyer will complete an impulse purchase is related to the ease with which the buyer can locate the impulse article. This principle seems to apply whether the buyer is shopping utilizing an E-Commerce website or traditional bricks and mortar type store.

Once the buyer has found the desired item in the store, the buyer may proceed to the checkout to wait in a checkout queue. Additional delays may be encountered in the checkout queue. The checkout queue may be long and individuals ahead of the buyer in the queue may take long periods to complete their transaction. If for example an item is not located within the checkout scanner computer and the price must be located, if a person checking out is paying with a credit card that needs an inordinately long period to authorize, or if an individual who is writing a check has difficulty in procuring the proper authorization, the time spent in the checkout queue can be burdensome. Excessive time spent in actually purchasing an item is a major factor in causing users to abort their transactions.

Although one of the advantages of E-Commerce is that it can be orders of magnitude faster and easier than traditional brick and mortars commerce. The ease and speed with which a transaction can be completed are still major factors in determining whether the transaction is actually completed.

In order to keep the shopping experience relatively fast and, therefore, more pleasant, many E-Commerce website designers attempt to optimize web pages to allow quick navigation through their sites. For example, web page designers may limit the amount of graphics, the resolution of the graphics, and the size of the graphics images so that the amount of data which must be streamed to a user is minimized. If the amount of data which must be streamed to a user is minimized, the website navigation speed can be increased. The tradeoffs for the accelerated navigation may be lower resolution graphics, smaller graphics displays, and very little use of transmission packet intensive techniques, such as video streaming and audio streaming. Website designers may, generally, trade off extensive graphics and data intensive techniques, such as video streaming, in order to promote a faster shopping experience. By limiting the amount of data which must be streamed to a user in order to enable the user to navigate the E-Commerce website, the speed of navigation of a site may be increased.

The shopping experience is also highly dependent on the user's computer system. If a user does not have the particular software necessary to receive data streamed from an E-Commerce website, the user will encounter delays in the shopping experience. Users may be forced to locate and download the necessary software, such as browser plug-ins, which will enable them to access the data from the E-Commerce website. Additionally, older equipment, lack of computer memory and slow modem speeds may render a user's system incapable of handling some of the more demanding web pages.

Other factors that increase delays for the user can significantly diminish the shopping experience. Some delays, however, are endemic to the nature of the Internet. Data transport across the Internet to a remote site, as well as packetizing information into discreet data packets, takes a finite amount of time and therefore produces delay. Whether a user can switch between web pages within a second or two or must wait 20 or 30 seconds to access successive web pages or even return to a previous page can be a critically important factor in determining which transactions complete with a sale, and which complete with the user aborting the shopping experience. Delays beyond 8 seconds in loading a web page can be extremely detrimental to the probability that the user will complete the website interaction with a purchase. Additionally, faster websites will generally develop a reputation as providing an enhanced shopping experience. Such a reputation can provide great advantages in the E-Commerce industry. This is similar to brick and mortar shopping experience, in that the difficulty and bottlenecks inherent in the shopping experience can adversely affect the likelihood of completing a purchase while faster checkout lines can provide an advantageous reputation.

The E-Commerce shopping experience can also be compared to a print catalog shopping experience. A catalog shopping experience is a method of direct marketing, in which a person is provided a printed catalog and then researches the catalog in order to determine which items to order. Once the individual decides on the item or items to be purchased, the individual must then perform a separate action to complete the purchase. The action may involve filling out a form and mailing it to a company or it may involve the calling of an order line, such as an “800” telephone number. Such 800 telephone number order lines may have their own annoying attributes. Commonly, 800 numbers do not connect a person directly to a sales clerk who will take an order. Instead, the caller typically must go through a series of telephone menus and keypad entries in order to select the proper routing of the call. For example, the same 800 number may be used for taking orders and may also be used for procuring return authorization, customer inquiries, billing questions, shipping inquiries or a variety of other uses.

A printed catalog, however, can have advantages over E-Commerce shopping. A person using a printed catalog can quickly flip through the pages and access a large variety of high definition product images within mere seconds, without having to download or wait for an image to build on a computer display.

However, direct marketing through printed catalogs also have difficulties. For example, even though printed catalogs are often sent to a targeted audience, only a very small percentage of the catalogs result in actual product orders. Additionally, when a printed catalog is sent, aside from the name, address and whatever criterion caused the printed catalog to be sent out in the first place, typically little is known about the person to whom the printed catalog is sent. E-Commerce ordering, on the other hand, provides considerable information about the person ordering a product. Because E-Commerce ordering is an interactive experience, a customer may be asked to provide answers to questions, directly. Additionally, when a user shops using an E-Commerce site, the particular items in which the user has expressed an interest may be observed or recorded, by observing or recording which website pages were opened onto the purchaser's computer. It is almost impossible, with a print catalog, to find out which pages provided the most customer appeal. While there is some indication of user preferences from the amount of orders generated for the items on each page, there is no indication of how much time a catalog recipient spends looking at the various pages in a print catalog. In contrast, and E-Commerce provider may observe or record how much time was spent viewing each web page. Such customer data can provide valuable feedback to a merchant.

### SUMMARY OF THE DISCLOSURE

Accordingly, to overcome limitations in the prior art described above, and to overcome other limitations that will become apparent upon reading the present specification, preferred embodiments of the present invention relate, to systems, methods and articles of manufacture which provide a shopping experience which combines many of the advantages of bricks & mortar and catalog shopping with an improved E-Commerce experience.

In particular, preferred embodiments of the present invention provide an “Interactive Media Site” (IMS). The Interactive Media Site is a new way to provide an E-Commerce site to individuals desiring an interactive media shopping experience without delays and drawbacks of shopping from conventional Internet websites. The IMS provides an E-Commerce site integrated and placed on a portable mass storage media, for example, but not limited to, a CD-ROM or DVD (Digital Versatile Disk). Such an Interactive Media Site EMS) can be loaded from the mass storage media onto the local memory of a user's “host device,” and kept in memory for fast access.

Because the IMS is actually local to the user's computer system, bottlenecks, such as an Internet connection, between the merchant site and the individual customer may be removed. Such a system, loaded from the mass storage media onto the “host device”, may supply all of the necessary pieces to provide a shopping experience similar to, but more advantageous in many ways over, an E-Commerce shopping experience taking place over the Internet. Such a system provided on a mass storage media or downloaded to a computer is referred to as a Brand Blaster, or its acronym, “BB.” A “BB” may contain several components. One component of a BB is a virtual streaming multimedia server (VSMS). The VSMS performs the same function as a merchant's remote Internet server in a common E-Commerce System, except the BB is loaded into the memory of the user's local “host device.”

The VSMS will appear to a user to stream multimedia content to the user's host device just as would a common Internet connected web site. However, since the VSMS is in the local memory of the host device, the streaming from the Internet is eliminated or reduced. Because multimedia content is available from the local memory within the host device, all streaming delays associated with the Internet are eliminated with respect to such local content. Streaming may take place from local memory, for example, from the local BB CD ROM controlled by the VSMS.

In preferred embodiments, the BB contains a search engine to allow the user to search for different products advertised or described within the BB. The BB may be configured to provide a user interface that appears to the user to be very similar to conventional browsers. In this way the user may be familiar with the interface and may not have to learn a new interface for interacting with the BB.

Also in preferred embodiments, the BB contains a software module to run transactive content, that is to manage the user/machine E-Commerce interactions. The transactive content engine, or TCE, may be equipped with multimedia capabilities, including a sound and video player, which could be optimized during the installation process of the BB software on a user's “host device,” thereby taking into account variations inherent in different user systems. The TCE may perform some functions similar to conventional browsers and plug ins. However, unlike conventional browsers the TCE may be optimized during installation.

Current Internet technology is based upon a “Client-Server” model, whereby a merchant's Internet Server is designed to accommodate (i.e., “Serve”) 10's of thousands of user's computers (“Clients”) accessing the server via the Internet at the same time. In contrast, preferred embodiments of the VSMS (also known as the eX-Virtual Server) with its E-Commerce engine serve only a single client or user at a time, and user's files are loaded from the BBS source. Since the files to be loaded are located locally, delays associated with file loading from an Internet site and data packet transmissions, both on the Merchant's server as well as to the user's host device connection, are eliminated with respect to such files.

The VSMS can eliminate many of the drawbacks of current E-Commerce services. For example, because the VSMS is a virtual server and contained within the BB system on the user's host device, all operations may be conducted within the host device. Additionally, the use of a telephone modem and the consequential tying up of the telephone line for E-Commerce shopping or any other Internet use is eliminated.

Loading a BB onto a user's system launches a Virtual Streaming Multimedia Server (VSMS). The VSMS is an enclosed software operating system which may provide such facilities as a shopping-cart mechanism and E-Commerce server, and a Streaming Multimedia Transactional Conditioner (SMTC). The SMTC is an assembly of memory management algorithms and rules used during the loading of the VSMS to perform an analysis of the user's host device and to determine the thresholds of optimal operation for the BB's transactive content. For example, if a user's host device has low memory the VSMS may load less memory intensive routines for performing necessary functions. In addition, the VSMS may save a user's system settings and insert its own settings for use by the BB system. When the BB system is no longer in use, then the user's previous settings may be restored. In this manner, the user's host device may be modified during the period of time that the BB system is being run, in order to optimize the local resources for the BB's needs.

An entire BB system may be contained on a CD ROM media and may be designed to fit on CD media having dimensions resembling, for example, a credit card or larger. The BB may also contain video files, sound files, graphics images, client product catalogues as well as shopping and checkout pages. The user would be able to privately shop and buy products from the VSMS system and then have his or her purchases processed by the VSMS interface without the necessity of being online in order to view content and make product selections and register purchases. The VSMS interfaces may then provide an EPO (Electronic Purchasing Order), which may be sent to a company server in merely a few seconds. Additionally, the EPO may be sent via a variety of other means. For example, the order may be sent to a remote site using simply a telephone modem on the user system. In this way a merchant may have an E-Commerce presence without having an actual Internet website.

Alternatively, the BB system may be programmed to generate an order, which may be sent via e-mail or even printed out and sent to the merchant via a postal mail service or faxed to the merchant directly. This flexibility provides the ability for a customer to choose the mode of ordering with which they feel most comfortable. Commonly the BB system will place an order to a server that is provided for that purpose. Such a dedicated server (eX-Mother Server) may be located, for example, at a local ISP. Orders generated by the VSMS may then be sent, for example, via modem to the local ISP where they will be routed directly to the dedicated eX-Mother Server. Because the eX-Mother Server is located at the ISP, an order generated at a VSMS can travel to the eX-Mother Server without ever traversing the Internet.

Additionally since the eX-Mother Server is dedicated to BB commerce, it can provide updates to the BB, for example, providing new pricing for items on sale or adding items to a catalogue. This may be done, for example, when a BB in first put into a user's PC. At that time, the BB may send a query to the eX-Mother for any updates for a particular company or merchant. If there is an update, or if there is a special “sale” of the products on that particular BB, instructions are given to the VSMS to create/generate the required new pages, either hard coded or virtually, seamlessly for the user. Such “instructions” may be given by the eX-Mother from an HTML page generation template which the VSMS has present. The entire transmission may take less than 2 seconds. Additionally the data which is communicated between the BB and the eX-Mother Server is small as compared with typical Internet E-Commerce data transfers.

Upon a customer placing an order to the remote server (“eX-Mother Server”), the eX-Mother Server may enable preferred E-Commerce credit card processing through a standard credit card authorization clearinghouse company which will return coded authorization status. The eX-Mother Server will then send back approval/disapproval data to the VSMS on the BB which may then be viewed in a newly created HTML window by the user on the user's local host system. For example, a new browser window generated by the VSMS may produce a message on the user's display to inform the user that the credit card has been disapproved, such as: “Sorry your credit card was not approved or you entered the wrong card number. Please try again with another card.”

In other preferred embodiments, the VSMS can be used in conjunction with a link to merchants sites. Such a link, of course, may be the Internet, a telephone line, a cable modem, a wireless link including radio frequency RF, microwave or satellite, or a variety of other communications links. Through such a link, the VSMS may provide credit card data directly to the merchant, for example, to allow the merchant to provide approve or disapprove and provide an appropriate response to the VSMS, which may then operate with the user's host system, as described above.

Because the VSMS can contain many of the large files and streaming video that would otherwise have to be transmitted across a communications connection, remote pages may be loaded much faster due to Localized Memory Cacheing (LMC) techniques which may be a part of the Streaming Multimedia Transactional Conditioner. The use of LMC may further enhance the user shopping experience and eliminate many of the delays inherent in the transfer of large data files, which are so common with other forms of Internet E-Commerce.

A user may, for example, make use of the BB which can link the BB to a remote server. While the user, effectively, never leaves the Interactive Media Site that is provided by loading the BB on the user's system, the BB may be in contact with and controlling a remote server through the use of embedded commands, such as may be provided by a language designed for that purpose. Such command may be embedded within HTML pages on the BB or may exist as extensions to the eX-Virtual Server (VSMS). By having much of the functionality of the Interactive Media Site and the data needed for the transactive experience resident locally, commonly experienced Internet bottle-necks may be eliminated or, at least, minimized.

Embodiments of the present invention have applicability for user profiling and “data mining” techniques that may be utilized to track the user's path through a BB's transactive content. This data may then be later sent to the merchant or company that provided the BB, for example, when an order is generated. Such user profiling and data mining techniques may provide to the merchant, or others, valuable insights into shopping habits of the purchaser.

The user may also take advantage of the data mining. For example, when a catalogue recipient thumbs through a print catalogue, certain pages may be of interest to the recipient. Later, if the recipient decides to procure a product seen on one of the pages of the print catalogue, the recipient may find it difficult to locate the particular page that contains that product. By using embodiments of the present system, the user may be presented with a trail of “product pages” or items, which had previously been accessed by the user, within the IMS. In addition, or as an alternative, the user may select and “bookmark” pages of interest, as the user browses through the content in the IMS. The VSMS may be configured to fashion customized pages from the bookmarked selections entered by the user as the IMS product pages are viewed. For example, after one or more shopping or browsing experiences, a user may generate a timeline, based upon category and interest of their past shopping or browsing behavior, in order to help the user quickly locate items which interested them.

Using such historical data, a merchant or company promoting their products on the BB may determine how long a potential customer spends on different pages and views different products. The merchant or company can also find out what content a user accessed and what products the user viewed, even if no purchase occurred. For example, the user's BB history may be sent to eX-Mother for data-mining when the user next logs on to the Internet or, alternatively, the VSMS itself may automatically log the user's modem onto the Internet and send this data. When the user finally does purchase a product the merchant or company is able to tell how long it took to finally make the sale.

Additionally the historical data can reveal a user's interest that can then be used to arrange the future presentation of items on the IMS. For example if a user is shopping for running shoes the historical data may show such an interest. Then, if another BB is loaded on the user's host device, it can detect this interest and rearrange the IMS to present pages featuring running shoes to be presented first. In other words a user's preferences could be used to determine the presentation of future information, content, web page arrangement, and the like, such as may be on further BBs.

These and other features and advantages of embodiments of the present system will become apparent by reading and understanding the present specification in conjunction with the drawing provided herein.

### BRIEF DESCRIPTION OF THE DRAWINGS

Referring now drawings in which consistent numbers refer to like elements throughout the drawings.

FIG. 1 is a block diagram of prior art E-Commerce system illustrating a user's computer coupled to an E-Commerce server via the Internet.

FIG. 2A is a graphic illustration of a system contained within a host device according to embodiments of the invention.

FIG. 2B is a graphic illustration of a system according to further embodiments of the invention, including portions of the system contained within a host device and portions of the system outside of the host device.

FIG. 3 is a flow diagram illustrating a process of checkout and installation of software on the user's host device according to an embodiment of the invention.

FIG. 4 is a flow diagram further illustrating a process of checking user's host device hardware according to embodiments of the invention.

FIG. 5 is a flow diagram further illustrating a process of checking user's host device software according to embodiments of the invention.

FIG. 6 is a flow diagram further illustrating a process of checking user's host device connectivity according to embodiments of the invention.

FIG. 7A is a further illustration of a process of loading software to the host device according to embodiments of the invention.

FIG. 7B is an illustration of further portions of the process of FIG. 7A, showing interaction between an eX-Mother Server and a Virtual Streaming Multimedia Server, according to embodiments of the invention.

FIG. 8 is a block diagram illustrating a functional inner connection between an eX-Virtual Server, an E-Commerce engine and an eX-Browser according to embodiments of the invention.

FIG. 9 is a block diagram further illustrating system functionality according to embodiments of the invention.

FIG. 10 is further illustration of functions of an E-Commerce Engine according to embodiments of the invention.

FIG. 11 is a block diagram showing functions of an eX-Browser according to embodiments of the invention.

FIG. 12 is an illustration of portions of an exemplary electronic catalogue according to embodiments of the invention.

FIG. 13 is a graphical illustration of an exemplary implementation of the shopping diary function according to an embodiment of the invention.

### DETAILED DESCRIPTION OF PREFERRED EMBODIMENTS

In the following description, reference is made to the accompanying drawings, which form a part hereof, and in which is shown by way of illustration specific embodiments in which the invention may be practiced. It is to be understood that other embodiments may be utilized as structural changes may be made without departing from the scope and inventive concepts of the present disclosure.

Accordingly embodiments of the present invention relate, generally, to an E-Commerce system which may run on a variety of computing platforms. However, for the purposes of simplifying this disclosure, preferred embodiments are described in detail herein with relation to embodiments of the disclosed E-Commerce system, which run on host devices, for example, personal computers. This exemplary embodiment is chosen as an example likely to be familiar to those skilled in the art, but is not intended to limit the invention to the example embodiments. The examples disclosed are intended to illustrate the inventive aspects of this disclosure, which will apply in kind to other computing platform including, but not limited to, cable boxes.

As used herein, the term “host device” is intended to mean any device, which can display to the user associated electronic content encoded in remote and/or local storage media. The host device may be equipped with a peripheral device suitable for retrieving associated electronic content encoded in a local storage media. Also, the host device may be equipped with communications hardware and software suitable for retrieving associated electronic content encoded in a remote storage media through a remote server. In accordance with example embodiments of this invention, a host device may comprise, but is not limited to, an IBM personal computer (or clone), Macintosh computer, 3DO platform, Sega platform, or an interactive television set top device.

As used herein, the term “storage media” is intended to mean media for storing digital data and/or code such as, but not limited to, optical disks (for example, compact disks (CDs), flexible disks (for example, 51/4 floppy disks), rigid disks (for example, hard disks), tapes, game cartridges, memory cards (for example, PCMCIA card) or any other media suitable for use in a host device which performs the function of information storage. In one embodiment the storage media is removable from a host device, although permanent media or other storage media (for example, on a remote server) may also be used in accordance with this invention.

As used herein, associated electronic “content” includes, but is not limited to, selections which can contain information found in a conventional printed publication such as book, magazine, catalog or other printed document, or as found in other electronic platforms. As used herein, the term “selection” is intended to mean data and/or code and includes a grouping or combination of one or more files such as, but not limited to, software, still graphics, picture, text, audio recording, video recording or other data related to one another, suitable for display by a host device. For example, a selection may include the multimedia equivalent of a magazine article or a television program or a digitized song or a video game software program or a spread sheet for financial information. While in one embodiment, data and/or code selections are in multimedia form suitable for use in a multimedia host device, a single media host device may also be used with suitable selections in accordance with embodiments of the invention.

As used herein, the term “interactive media” is intended to mean any communication media with which a user may interact, such as, but not limited to, a computer, an interactive television or a video game machine.

As used herein, the term “display” is intended to mean presenting one or more selections by the host device in a form suitable for use by a human on a display device such as, but not limited to, a monitor/screen, a speaker/headset or a printer. Display may include running a software program, playing a sound recording (through a speaker/headset), showing a video recording (on a monitor/screen) or printing a graphics image (on a printer). As used herein, the term “use” is intended to include display, as well as any other use (processing use) in a host device.

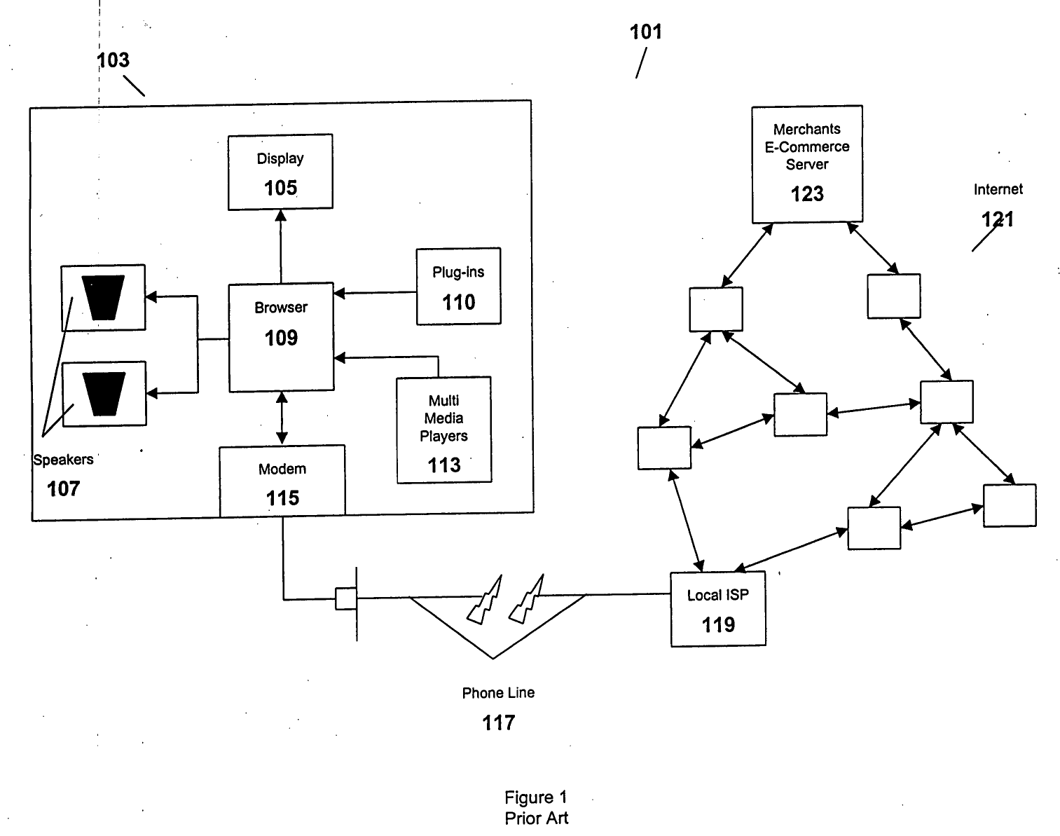

FIG. 1 is a block diagram of an exemplary prior art E-Commerce system 101 implemented utilizing a personal computer 103. Within the personal computer 103, a browser 109 is present. The browser sends graphic files to the display 105. Browser 109 may use multimedia player software 113 or plugins 110 in order to produce visual content for the display. The browser also provides signals for the speakers 107. The browser may rely on multimedia player software 113 or plugins 110 in order to produce the audio signals for speakers 107.

The browser is connected to a network via modem 115. The modem 115 couples the computer system 103 into the telephone line 117. The telephone line 117 then further couples the computer 103 to a local Internet Service Provider (ISP) 119. Other embodiments may employ other methods for Internet connectivity such as Digital Subscriber Line (DSL) Cable Modem or wireless.

The computer 103 is located at a user's (for example, a buyer's) location and is coupled, via the telephone line 117, through the Internet 121 with the merchant E-Commerce server 123. Visual displays, audio content, web pages and other data are communicated between the merchant's remote E-Commerce server 123 and the buyer's computer 103, via file download or video streaming techniques. In addition, the buyers computer may also access the Internet in order to download data from different sites, multimedia players 113 or plugins 110 which are necessary for the browser 109 in order to run, load or stream different types of media files provided by the merchant's E-Commerce server 123.

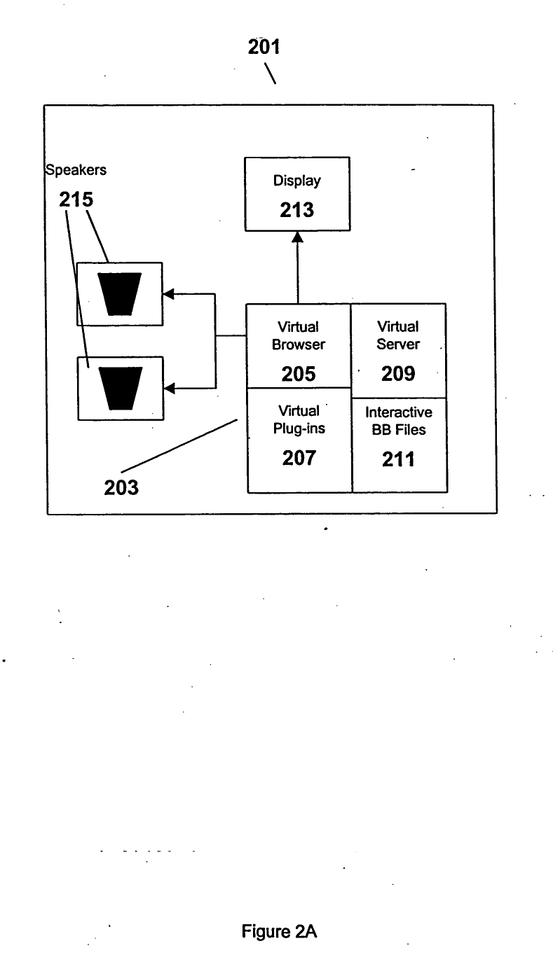

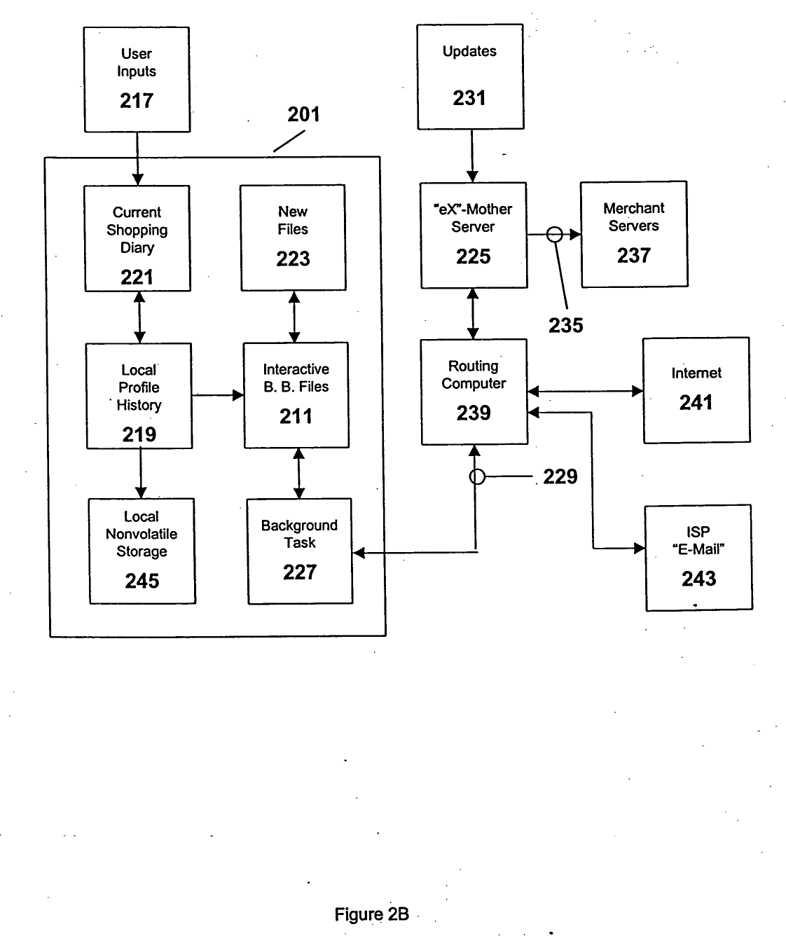

FIG. 2A is a block diagram of a simplified exemplary embodiment of the present invention. The embodiment of the present invention illustrated in FIG. 2A comprises a software system 203 composed of software stored on computer readable media. In the illustrated embodiment, the software system 203 is contained within a user host device which, as an exemplary embodiment, comprises a personal computer 201. For example, the software system 203 may be stored on a hard disk or may be stored on a portable medium, including, but not limited to, a CD, a floppy disc, a digital tape or the like, which may be loaded into and read by the computer 201.

The VSMS/BB software system 203 according to an exemplary embodiment is composed of a virtual browser 205, which interacts with a virtual server 209. The virtual server 209 draws upon interactive files 211 on the BB which may comprise such content items as video and audio graphics files, web page files, JPEG files, GIF files, etc. The virtual browser 205 interprets files provided to it by the virtual server module 209 and may use virtual plug-ins 207. The embodiment 203 may use the aforementioned components to provide audio to speakers 215 and graphics to display 213. A user of BB Interactive Media Site may not even be aware that the site being accessed is local to the user's host device, except that a significant performance improvement will be present over an interactive website connected via the Internet.

FIG. 2A does not show a connection to the telephone line, an Internet service provider, the Internet or a remote commerce server because those pieces are not necessary to produce an interactive, transactive, or E-Commerce experience according to certain embodiments of the present invention. Accordingly, the delays associated with those pieces have been eliminated. The appearance, however, and look and feel of an on-line Internet E-Commerce shopping experience may be maintained and effectively improved and enhanced. One way in which the shopping experience may be improved is that all elements within the present embodiment are tightly integrated and work when they are loaded.

Embodiments of the present invention have a highly reliable operation because when the BB system is installed from a BB mass storage media (e.g., CD ROM) to the user's system, the system can be checked to assure that it will run the software present on the BB media. In contrast, when a user browses an on-line website, the individual may never be sure if his or her computer will be able to access the site properly. The user's computer may not contain the requisite hardware, and software—such as audio video players, which may have to be downloaded from other websites.

If a system without the proper plugins connects to a merchant's Remote Internet server, the shopping session may have to be lengthened or stopped in order to find and load the plugins 110 necessary to interpret data from the merchant's E-Commerce server 123. Also, if the user's system is lacking the requisite hardware, the E-Commerce session may have to be terminated. Thus, a user may initiate an E-Commerce session only to find out that the session cannot be completed without additional installation of hardware or software into their system.

In contrast, a loaded BB system as exemplified in FIG. 2A will work upon commencement of the software program loaded from the BB on the user's host device because the BB checks and optimizes the user's system prior to attempting to run. The BB also may inform the user of the shortcomings of the user's system that may prevent the BB from performing optimally. For example, BB if the user's system does not have the proper TCP/IP drivers installed, during the BB installation and host system analysis, the user might receive a message such as, “Please install your Windows Dialup Networking (click here for instructions) so that the BB can communicate to our Internet server to place your orders.” Because the software delivered to the user's computer system by the BB is contained within a mass storage device, it may be installed to a user system in such a way as to optimize its performance. The VSMS Installation System may install certain drivers or other components as necessary to optimize the host system's memory or video resources as needed.

During the installation process, the BB content may be updated. If the BB is not the latest version or if the product prices have been changed as in a sale, then some of the product information contained within the BB may be out of date. During the installation, the BB can establish a connection to the eX-Mother Server and provide version information of the BB to the eX-Mother Server. The eX-Mother Server then can respond with any update necessary to bring the BB into a current configuration. Such updates may be stored to the user's hard disk or may be loaded into RAM memory.

In addition, the BB may communicate profiling information to the eX-Mother Server. The eX-Mother Server may then use this profiling information, for example, to rearrange the pages of a catalogue according to the user's interests in past products. The eX-Mother Server may also present and/or highlight information such as sales that are pertinent to the user's profile. In other words, the eX-Mother Server can receive information about the user's preferences and tailor specific communications to those preferences.

FIG. 2B is a block diagram of a simplified exemplary embodiment of the present invention. The embodiment of the present invention illustrated in FIG. 2B is contained within a user host device. The user host device may be any one or combination of a variety of computing type platforms such as, but not limited to, a television set top box, a gaming console, a personal computer or a PDA (personal digital assistant). The principles illustrated in FIG. 2B are not limited to a single computing platform but may be applied to a variety of computing platforms. For the sake of simplifying the present disclosure, however, FIG. 2B is illustrated with respect to a personal computing platform.

FIG. 2B illustrates a personal computer on which BB software has been loaded. The BB software comprises a virtual browser 205, a virtual server 209, virtual plugins 207 and interactive BB files 211 as illustrated at 203 in FIG. 2A. The embodiment in FIG. 2B contains software for producing an Interactive Media Site (IMS) on a user's host system, in this case a PC. Because the software necessary to produce an interactive media site is located locally within the user's host PC 201, the performance of the interactive media site is limited only by the speed of the platform on which it runs. There are no limitations or bottlenecks associated with streaming or downloading files from another location over a network connection.

Although bottlenecks caused by the necessity of streaming files or downloading files from a remote site have been eliminated, embodiments of the invention may nonetheless comprise an external link 229. The external link 229 need not be used for streaming files that are to be displayed to a user. Instead the external link 229 is coupled to a background task 227 within the computing system 201 and may be used for a variety of other purposes.

The background task 227 and external link 229 is coupled to an eX-Mother Server 225. The eX-Mother Server 225 is a local type of server and the external link 229 is a local type of link. A local link is a high speed direct connection between a background task and the eX-Mother Server 225. A local link does not contain a series of intermediate links. A local link also does not traverse a portion of the Internet. A local link connects the user's computing system 201, via a background task 227, to the eX-Mother Server 225 in a site to site type connection. By site to site connection it is meant that the first site comprises the user's computing system 201 and the second site comprises the site which houses the—eX-Mother Server 225.

Such a site may also comprise a routing computer 239. This is because the eX-Mother Server may be located at an Internet service provider's (ISP) site. The Internet service provider would receive communications in its routing computer 239 and then route the communications to the proper destination. The routing computer may route the communications to the Internet 241, to an ISP e-mail service 243 or in the case of the present embodiment, may route the communications, such as 229, to the eX-Mother Server 225. The eX-Mother Server 225 may be, in turn, coupled to merchant's servers 237 across an Internet connection 235. The Internet connection 235 will not, however, affect the speed of the interactive media site as hosted on the computer system 201.

The BB interactive media site hosted on computer system 201 is substantially self-contained. The user of the system accesses files which are resident on the system only. The external connection 229 may be used for purposes such as providing new interactive BB files 211. Any material or files which are delivered to the computer system 201 via an external link 229 are not available to the user until they are completely resident on the user's computer system 201. The external connection 229 may also be used to transfer a purchasing order to merchant's servers 237 via the eX-Mother Server 225. This transfer may occur as a background task or it may occur when the user is no longer accessing the interactive media site. In either case, there is no waiting for files to be delivered from a remote site.

As an example, a BB system may be used to create an interactive media site which sells office supplies. The office supply merchant may also have a promotion or sale during a certain period of the year. If the user of a BB system connects to the eX-Mother Server via a background task 227 and external link 229, sales material relating to an office supply sale may be downloaded as interactive BB files 211. The choice, however, to view these interactive BB files 211 which represent the yearly sale of the office supply merchant, are not present to the user as a choice for viewing until the entire file has been downloaded by the background task 227 and is resident as an interactive BB file 211. If a choice were available such as prompting a user if they wished to download a sales file, then the user would experience the normal type delays to download the files during the experience. In preferred embodiments of a VSMS/BB system running an Interactive Media Site, however, no choice is presented to the user until the files are present as interactive BB files 211. By not presenting a choice to a user to view a file until it is actually present on the user's machine, delays associated with downloading files from remote sites are eliminated. These delays are eliminated whether the file being viewed by the user is one of the original files loaded from the BB media, for example, CD-ROM, or one that has been downloaded by a background task 227. Once the files have been downloaded by the background task 227 the new files 223 are available just as any other interactive BB file 211.

A significant difference between BB interactive commerce and normal E-Commerce is illustrated by the one-way communications direction between the eXtreming mother server 225 and the merchant's server 237. In a conventional E-Commerce experience a user would access web pages from a merchant's server, which would be streamed to the user. As the user changed web pages, further web pages would be streamed from the merchant's server to the user. The display of all web pages on a user's system would, therefore, involve a handshaking between the merchant's server and the user's system. A user would call for a new web page and the merchant's server would then stream the web page to the user. If the user wished to access one of the links on the web page, the user would activate the link which would then be communicated to the merchant's server. The merchant's server would then stream the necessary page represented by the link to the user.

Internet Website pages with more than a minimal number of graphics may have to be reloaded each time a user returns to the same page to look at them again. If the loading of a web page originally took 30 seconds to 1 minute to load from the Internet, it probably will probably take the same amount of time to load again. With the BB System, pages and graphics may be background loaded into the user's host device's RAM Memory either upon installation or when first accessed and remain in memory. Many pages and graphics may be simultaneously loaded into RAM, independent of control from a browser. Accordingly, when a shopper returns to a previously viewed page the IMS webpage can load instantly from local RAM every time.

Additionally the BB system of FIG. 2B does not require such a handshaking link between the eX-Mother Server 227 and the user's system 201. The user's system 201 preferably contains within it all of the merchant's pages that will be used by the system 201 including forms which the user may need to complete their purchase. If a user clicks on a link displayed on the BB's Interactive Media Site, the page to link to is immediately available. The linked page is immediately available because it is resident in RAM in the user's system 201. Once the ordering process has been completed on the user's system 201, the order may be sent to the merchant's server through the background task 227 or may be delayed and sent at a future time. In either case, the user completes the interactive media or shopping experience as well as the filling in of any forms using only files available locally on their system.

The user may transfer a request or purchasing order via the background task 227 to the merchant's server 237. The request or purchasing order represents a relatively small data file when compared with the transfer of web page files. Additionally, the transfer is made in one direction, from the user's computer system 201 to the eX-Mother Server 225 where it is processed and may be further sent to the merchant's server 237.

Even if the merchant's server 237 is down or experiencing delays, the user's order may be held in the eX-Mother Server 225 and delivered to the merchant's server 225 at a later time. Because the connection between the user's computer system 201 and the eX-Mother Server 225 is a direct immediate type connection, any order which is transferred from the BB system running on the interactive media site may be transferred to eXtreming mother server very quickly.

Another advantage provided by BB software system is that several merchants may participate in the interactive media site running on the user's computer system 201. The user may complete orders from several different merchants and such orders may be sent in a short period of time, comprising seconds, to the eX-Mother Server 225. The eX-Mother Server (eXtreming mother server) 225 may then relay the orders to the proper merchant's servers 237.

A further advantage of BB type commerce is that a user's profile, including credit card information, may be stored on the user's system 201, for example, in local non-volatile storage 245. Because this storage is local, it can be used by multiple BB's. For example, if the user receives a first BB from a first merchant and completed a local profile 219 identifying the user's name, address, phone number, and preferred method of shipping, etc., that profile could be stored on local non-volatile storage 245, such as a user's hard disk. When the user inserts a second BB, at a later time, from the same or another merchant into the user's system 201 at a later time, there would be no need to enter in their registration profile information again as it would all be available locally in the local non-volatile storage 245. Such local non-volatile storage would enable a user to make multiple purchasing orders from multiple merchants and may never have to re-enter their user information. The user information would be stored in a local non-volatile storage 245 in a form accessible to all BB's which the user were to use. In this manner, an order could be completed by a single click and the user's information, and purchasing order, which are both resident in the user's system 201, could then be sent. Additionally, the information in the local non-volatile storage 245 could be used to automatically fill in purchasing orders that are printed out and sent by traditional mail or by facsimile transmission. The local non-volatile storage 245 would thereby enhance the user's shopping experience by doing away with the necessity of entering in purchase information every time a new merchant was contacted and by providing a method by which a single action, such as a mouse click, could complete and send an order.

The eX-Mother Server can also facilitate the purchasing of items from multiple vendors. Billing information, such as user address, shipping means and credit card information, can be sent to the eX-Mother Server. The eX-Mother Server then can communicate with the various vendors and provide the individual vendors with a particular information that they demand to complete the transaction.

The VSMS uses an automatic html page generator to generate new or on sale HTML shopping cart pages, which are created from instructions received by the eX-Mother Server. The eX-Mother Server gets updates from polling participating merchant's Internet web servers, accessing previously setup databases, translating the database data, then directing each BB system to update its pages accordingly. Additionally, the Product Catalog File on the BB can be updated to allow further searches and enable the E-Commerce engine on the BB to select new products. All these actions may occur completely seamlessly without the user being aware that his modem is turning on for a few seconds communicating data then turning off. Graphics for certain “Sale” items or products, in anticipation or in coordination with the merchant's sales strategy, may already be present on the BB, as would be a HTML page creation template, which can enable users having out of date BBs to see the latest sale prices without ever knowing that they had been updated.

This form of communication between the BB software system, eX-Mother Server, merchant, and back again to the BB (in the case of credit card approval or disapproval for purchases) occurs by way of small data packet transmission instructions to and from the BB software system. In this manner a VSMS is able to get E-Commerce credit card approvals and update the Interactive Media Site it operates on the BB by communicating with the eX-Mother Server. No HTML or graphics images need to be uploaded or downloaded because the forms are resident on the BB and only necessary data is sent to the eX-Mother Server, so the updates and credit card approvals can occur in mere seconds. The rapidity of the process enhances the user's shopping experience.

A further function of the BB is that it may create a user's shopping diary. A user's diary may be a diary of bookmarks or bookmark categories which is created by the VSMS and which the user can use at any time to see pass categories, pages or products that the user has accessed. The user can then use this diary of bookmarks to return to items or sections of the BB store they were interested in. The VSMS can create HTML pages of the bookmarks by category and/or in the order that the user viewed them. The VSMS may also mark some of the bookmarks thus created with high interest markers signifying that the user had marked the item for return. The diary of bookmarks may also be used by the eX-Mother Server for the purpose of data profiling.

The VSMS can also search the diary of bookmarks and categorize them by both content and the order in which the items were selected.

The BB form of commerce also enables new features previously unavailable with conventional print catalogues, both to the merchant and to the consumer, as well as new forms of on-line shopping experiences. One such feature is that of producing a local profile 219. In addition to information such as address, billing and shipping information, a local profile 219 may comprise data associated with a user's shopping habits. For example, when a user interacts with a BB commerce system, the user provides inputs 217 to the computer system 201. Such inputs can be recorded and categorized in a shopping diary 221. A shopping diary could record the types of items in which a user had been interested in, for example, by recording data corresponding to which specific interactive media system pages were most often visited, how long the user visited the site, items which the user sought further information on by clicking on links and which products were eventually bought, or bought and later canceled This could be used to distinguish interests of a user while utilizing BB's containing multiple merchants' interactive media sites. In addition, within each merchant's site a particular type of item might be favored by a particular user. In addition to providing a feedback for the user, as discussed elsewhere, information in the shopping diary could be used to produce targeted commercials and promotions. For example, if a user was running a BB dedicated towards men's wear and had spent a significant amount of the time accessing pages displaying running shoes, such an interest could be recorded within the shopping diary. Once the user had established a connection 229 between their computer system 201 and the eXtreming mother server 225, the local profile containing the product interest showing that the user had been interested in running shoes could be sent to the mother server 225. Once the mother server 225 had received this information it could begin to download interactive BB files via the background task 227. Such files could represent several pages containing a more extensive offering for the products or lines in which the user showed an interest (e.g., athletic shoes) or it could contain an interactive commercial relating to such products or lines. If a commercial had been downloaded and was complete within the new files 223 within the BB system, then once a user entered the page showing the athletic shoes, a pop-up prompt such as “Here are more pages relating to running shoes which are now on sale!” could be presented. By signifying their acceptance the user would then be presented with the downloaded pages which contained running shoes which were on sale.

As an alternative, the user might be presented with links to new running shoes pages which were distinguished from previous links, through the use of such visual cues for example, but not limited to, highlighting the link and appending the word “new” to the link. Preferably, neither the commercial nor the new links would be presented to the user until all of the files to establish the link had been downloaded by the background task 227. In this way, although new files may be downloaded, the Interactive Media Site shopping experience within the BB software is kept fast and pleasant. No delays are required to wait for any files to be downloaded. If the user can access a file, then it is already present upon their system. Because any file that the user may access is already present on the user's system, access to such files is seemingly instantaneous.

In addition, advertisements which could be placed in response to the user's local profile are not only fast but immediate. In the previous example in which a user was shopping for running shoes, once they had accessed the page containing the running shoes, an immediate advertisement could be displayed. The advertisement might further use the shopping diary 221 and local profile 219 in order to personalize the advertisement. For example, instead of informing the user that there was a sale on running shoes and that the user may view pages on the interactive media site containing running shoes which are on sale, the user could be given pertinent information such as, for instance, shipping times and options to their particular address. The system could determine the user's address from the local profile which is stored in local non-volatile storage 245 and could address the user by name. So, instead of merely an advertisement saying that Nike running shoes are on sale, the advertisement could say, “Hello, Mr. Smith, Nike running shoes are on sale now and can be delivered to your home at 1342 Woodland Hills for a shipping charge of $3.00 per pair. Shipping will take 3 days by UPS Ground and for an additional $5.00 can be shipped by UPS Next Day Air.” Additionally, reaction to such commercials could be gauged and stored in the shopping diary 221. If the item were then procured, the merchant would have a gauge of the effectiveness of the commercial. In such a way the interactive commercials could be tailored to the particular user using the shopping diary 221. For example, if the shopping diary showed that the user spent an average of ten seconds on each interactive media site page before clicking to the next page a pop-up advertising might be most effective. In contrast if a user spent 2 minutes considering each page then perhaps just an entry in a current page showing that sale items were available would be more effective. Merchants can also tell if a person does not order anything—what they looked at during their “window shopping as well as the duration of their stay. Since this information can be continuously saved to the user's hard disk then transmitted to eX-Mother at various intervals. In this manner nothing is lost if the user decides to take out the BB CD or turn off the host device before all the information is sent. In the event that BB is removed before the information is sent to the eX-Mother Server, a data packet may be saved to the startup section of the windows registry on the user's host device 245 so that the next time the user turns his host device on, or logs back onto the Internet, the saved profiling information will be automatically sent to eX-Mother.

Additionally, this pre-registration data, using the user's information left by a previous BB, may be used to fill out new forms with the user's personal data so that the user does not have to re-write such information.

In addition to providing a feedback for the user (items bookmarked by category and personal interest), information in the shopping diary 221 could be used to heighten sales to returning users of BBs, wherein the user's previously recorded profile history 219 is read when a new BB is inserted into the user's host device 201. If the category of products are similar in the profile history. 219, as on the newly inserted BB 203, for example, a new clothing catalog from a different manufacturer, then the BB's VSMS may reorganize its display of new products files 211 to feature or highlight the same category or type of products the user had showed interest in or purchased in the past, according to the user's profile history 219. The contents of each current shopping diary 221 is continuously saved in the local profile history 219. This method, called Intelligent Offline Media Sales Identification (IOMSI), can speed up and increase a merchant's Point of Sale activity significantly.

Additionally, each BB has its own serial number. When the user's previously recorded profile history 219 is read, upon inserting a new BB into his host device 201, the serial numbers of the new and previous BB are linked in the eX-Mother Server's database. This further enhances the profiling capabilities provided for a merchant by the BB, beyond those which could be derived from current print catalogs.

Merchants could then refine their future BB offerings and general sales and marketing strategy by gathering statistics from one or more (and preferably many) user shopping diaries. The merchant could then send targeted promotions and commercials via background tasks to users' interactive media sites via the eX-Mother servers. Merchant's could then observe which types of commercials were the most successful and coordinate the different types of immediate advertisements to the user's behavior as recorded in the shopping diary 221. In such a manner, merchants could gauge the effectiveness of multiple ways of presenting products to individuals who had expressed an interest in that type of product. Because the advertising could be made immediate and not subject to download delays from a remote server, merchants could more effectively gauge the effectiveness of their ads and further promote the use of the BB Interactive Media Site as an advertising service. For example the eX-Mother Server may be programmed to allow a BB service provider to examine the user profile in real time. If the user profile 219 and shopping diary 221 indicated an interest in a certain type of item or category of items, data packets containing instructions as to an interactive advertisement, provided by either the same merchant or a merchant affiliate, could be quickly downloaded to the user's system via the eX-Mother Server. Once the advertisement data was downloaded the VSMS it could then be displayed to the user. The BB issuer could provide these targeted advertisement packets to its merchants. In addition, responses to specially designed interactive ads could then be analyzed in light of the existing local user profile 219 and shopping diary 221. Information from this real time analysis of purchasing demographics may then be provided to merchants as a service. A merchant can literally view how customers are using, viewing and purchasing products from the BB catalog systems—from the time users begin to access their BBs.

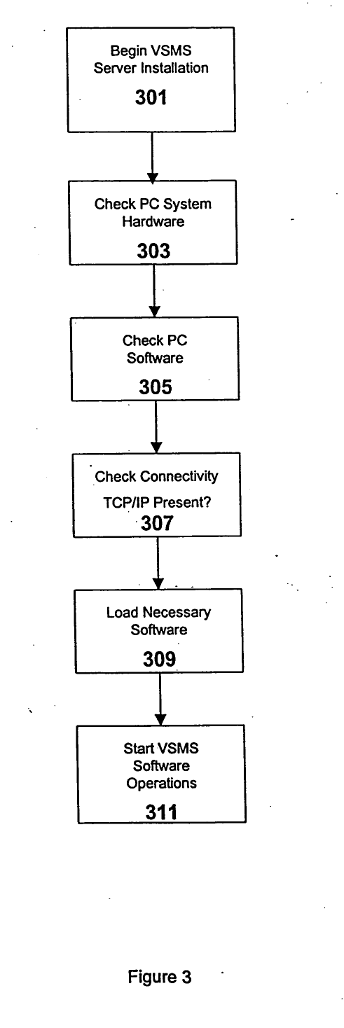

FIG. 3 is a general overview of a user's host system checkout and installation process of the Virtual Streaming Multimedia Server (VSMS) being installed from a BB to a user's computer system. The VSMS can provide the functionality that would ordinarily be provided by a merchant's E-Commerce Internet website. The process begins in 301, with the beginning of VSMS host device system optimization checkout and installation. The checkout and installation begins once a user has loaded a BB and begun to run the installation program portion. For example, one of the media from which BBs may be made available is in the form of a CD ROM. Once the BB is inserted into-the CD ROM drive and the drive closed, the program will begin to load according to conventional loading procedures.

In Block 303 the user's PC system hardware is assessed. The checkout and the installation routine will determine how much RAM memory is available in the host device. The amount of RAM needed could depend upon the BB application being loaded. An interactive media file that, for instance, makes heavy use of memory, such as displaying video clips, may need 128 megabytes of RAM memory or more on the host device. However, for a typical application, 64 megabytes of RAM memory could generally suffice. Based upon results thus determined, if the host device has low memory or slow memory, the VSMS will decide to load different format video files or graphics which require less RAM memory. Another possibility is if the VSMS finds an old processor, but with enough RAM memory, it may decide to load a file in the conventional manner, instead of fast streaming a video file, which may occur more slowly on systems having older processors.

The installation procedure also checks to ascertain what type of graphics card is present in the system. Sometimes graphics cards are set to less than full capability or are not properly installed. For example, a SVGA graphics card may be set to display VGA graphics. By determining the capabilities of the card, the application may attempt to maximize the quality of the shopping experience by setting the card to an optimal setting. Likewise, the type of sound card is determined. If no sound card is available, the system may be loaded without sound files. In addition, the installation and checkout routine will ascertain if Internet device drivers are properly installed and operational, if there is a modem or other internet connection device and whether or not such device is turned on.

In Block 305 the checkout routine checks the PC software. The system will ascertain what software and operating system is present on the user's system. If, for example, plugins needed by the BB are already available and operational on the user's system, there may be no reason to reload or install them from the BB.

In Block 307 the connectivity of the system is checked. The system check procedure 307 may involve determining such factors as whether or not the computer has an outside connection via a modem and a live telephone line or a continuous connection via a DSL line, wireless, or via a cable modem. Additionally, the checkout procedure may determine if there is a connection to an Internet provider. For example, if the computer system has a modem for communication over the Internet, the checkout procedure may determine if the modem is connected to a live telephone line, if the modem is turned on, and if the modem is on-line (connected to an Internet provider), or any one or combination of such factors. If the system check procedure 307 determines that the modem is connected, turned on and on-line, then the program proceeds to Block 309.

On the other hand, if the system check procedure 307 determines that the modem is not connected to a live telephone line, then, in one embodiment, the program provides a display or other form of message, informing the user that the modem is not connected (or, for example, requesting that the user connect the modem to a telephone jack). If the procedure 307 determines that the modem is not turned on, then, in one embodiment, the program provides a signal or instructions to the user's system or modem to effect an automatic turn-on (for example by operating an electronically activated switch to turn on or apply power to the modem). In addition or as an alternative, if procedure 307 determines that the modem is not turned on, then the program provides a display or other form of message, informing the user that the modem is not turned on (or, for example, requesting the user to turn on the modem).

If the modem is not already connected to the Internet, but is connected to a live telephone line, the VSMS may notify the user to turn the modem on, or install a modem if one is not present. If there is a modem connection, the VSMS may cause the modem to connect itself to the Internet. If the procedure 307 determines that the modem is not on-line, but is otherwise connected to a live telephone line (or other Internet connection), then the VSMS may notify the user to turn the modem on, or install a modem if one is not present. If there is a modem connection, the VSMS may cause the modem to connect itself to the Internet

Once the parameters of the system are known, the necessary CD ROM embedded software may be loaded, utilized and/or accessed from the BB Block 309. Once the necessary software is loaded the VSMS software process 311 may be started and the user may proceed with their E-Commerce shopping experience.

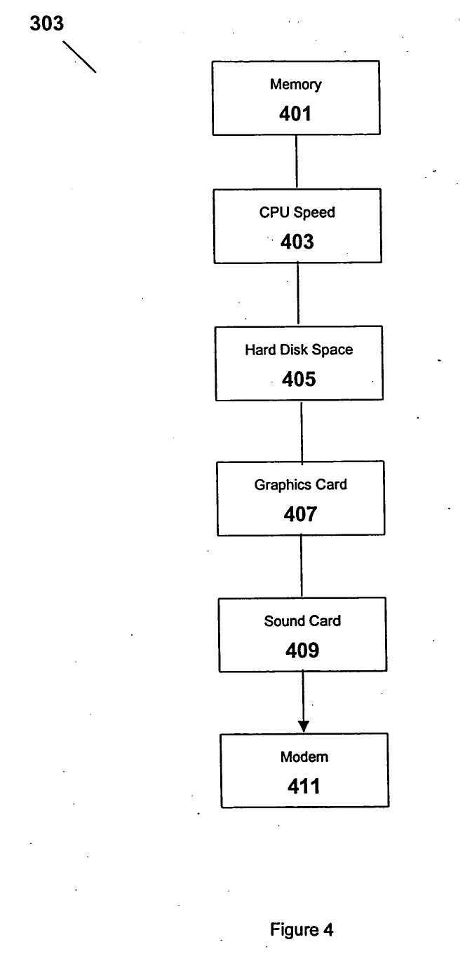

FIG. 4 is a graphic illustration, which elaborates on Block 303 of the installation and checkout routine, the block in which the PC system hardware is checked. For example, in preferred embodiments, an internal optimal performance report is created by determining and recording any one or combination the factors related to the PC system hardware, including, but not limited to CPU speed 403, hared disk space 405, graphics card 407, sound card 409 and modem 411. The results of the performance report may be used by the VSMS to alter its operations based upon existing, unchangeable conditions of the user's host device, so that the highest percentage of users will be able to operate the BB media site. In contrast, many conventional CD's containing special programs or music videos completely fail to operate when encountering non-operational conditions on a user's host device.

In Block 403, the CPU speed is ascertained. The CPU speed may determine a variety of parameters. For example, the CPU speed may determine the size of a video display which can be reasonably maintained at a good quality for that particular CPU speed. Because the presentation of the shopping experience may be adversely affected if the CPU speed is not adequate enough to run software in an acceptable manner, tradeoffs might be made during the installation qualification period. The user may be informed, through a display message, that certain video clips, for example, may be slow because of the speed of their system, or, the VSMS will substitute different media files which could play in a more optimized fashion on that user's system. If no media is determined to be able to play on the user's system because of the CPU requirements, a message will be displayed to the user. Additionally, a user may be given a notice such as “your system cannot run full size graphics; The Brand Blaster will adjust itself to your system.”

The amount of available hard disk space is checked in Block 405. The system determines how much hard disk space is available in order to determine how many of the files can be loaded on the hard disk. By loading files on the hard disk an improvement in access time may be obtained over loading such files from, for example, a CD ROM media.

Additionally, in Block 407, the type of graphic system present is determined. This will determine the display quality that the system may produce. It will also determine what types of files will need to be loaded on the system and whether or not the graphics card may be adjusted for a higher resolution. For example, the system may provide a message to the user, informing the user of such factors. By knowing the capabilities of the graphic system, the visual portion of the presentation may be optimized. Additionally, memory 401 may be optimized to enhance graphics data pumping ability.

In Block 409 the presence of a sound card is detected. A system may not have a sound card at all or may be a sound card not capable of handling certain audio players. Determining the sound card further allows the presentation to be tailored to the limitations of the user system, and to prewarn the user of any limitations encountered for example, by displaying suitable warning messages or giving instructions on making manual adjustments.

In Block 411, the existence of Internet TCP/IP dialup communication drivers are determined to be present. Then, the type of modem that is present is determined. If no TCP/IP drivers have been installed on the system, the VSMS will look for network connections or RAS (Remote Access Service) devices. If no RAS devices are present, then it may be the case that an Internet, dialup modem or fax connection is not possible. In that event, the VSMS may provide the user with a display of a suitable message, informing the user that a printed order may be created which may be mailed or otherwise delivered to the merchant by conventional means, such as a conventional telefacsimile machine, a messenger service, the postal service, or the like. Thus, in one embodiment, the entire interactive media site on the BB may be operated successfully, complete with e-commerce, without any on-line connection in this fashion.

Although the shopping experience is a local shopping experience with the virtual streaming multimedia server (VSMS) being located in the user's host device, the user may choose to send an order at a later time. Sending an order is a relatively light burden on the system compared with sending and receiving files and commands to and from a remote server in a typical on-line interactive environment. An order may be sent at the end of the user's shopping experience through the modem or at any time. If there is no Internet connection detected in the system (as discussed below), the VSMS will establish its own direct Internet connection to the eX-Mother Server or the modem may be used to send data to a dedicated order system. In the latter case, the data may be sent via telephone 800 line without requiring the merchant to have an E-Commerce Internet site. The use of a telephone line not connected to the Internet might also serve to allay fears of a transaction being eavesdropped over the Internet. The user of the system may have the full benefit of an E-Commerce experience without ever having to utilize the Internet. Additionally, an order may be printed and mailed (or sent by telefacsimile) to a merchant, should the user desire to, for example, include a check in lieu of providing credit card information.

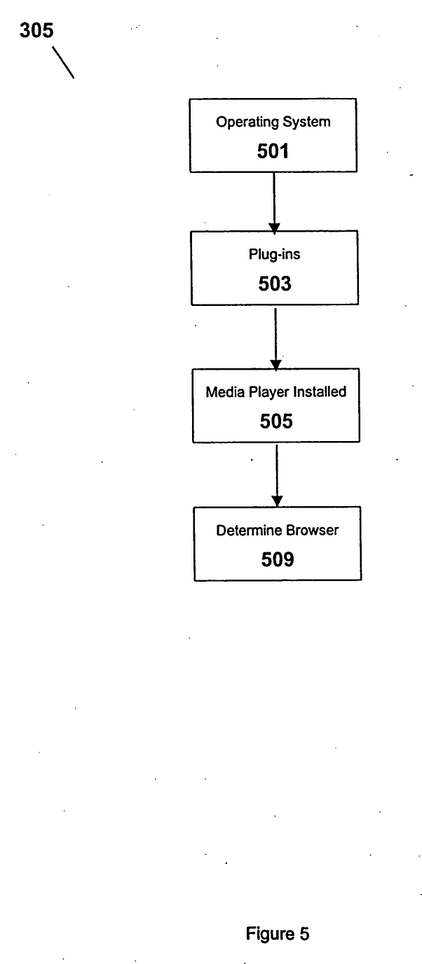

FIG. 5 is a block diagram elaboration of Block 305 in FIG. 3 in which the pre-installation and qualification software checks the software present on the user's PC. In Block 501 the pre-installation and checkout routines attempts to determine the operating system and the version of the operating system which is present. If the operating system and present version is known, then the VSMS routines may be able to optimize the shopping experience.

In Block 503 the system determines which plugins are present. If certain plugins that are needed within the VSMS system are already present, there will be no need to load duplicate copies from the BB.

In Block 505 the pre-installation routine ascertains what type of media players are already installed. If media players or their plug-ins that will be used by the VSMS software are already present, then they need not be re-installed.

In Block 509 the browsers present on the user system are determined. Although a electronically virtualized BB custom browser (Virtual X-Browser) may be installed and used to provide the user with their shopping experience, it may be preferable to know what type of browser is already installed. The Virtual X-browser may be configured with the same type of controls the user is familiar with on the user's own default browser.

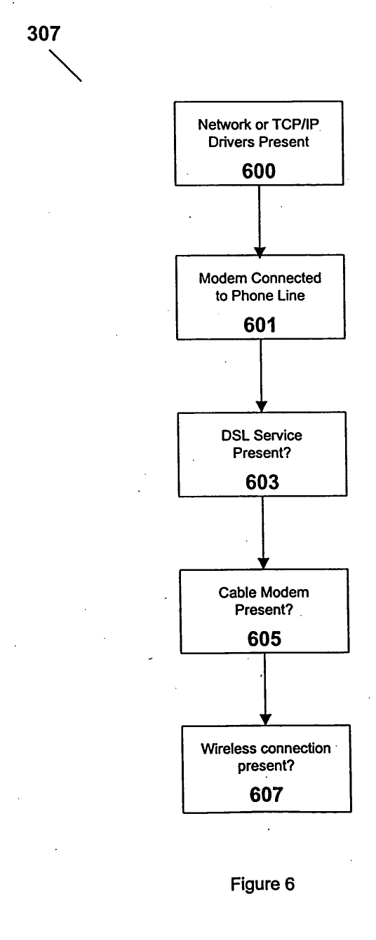

FIG. 6 is a block diagram, which is a expansion of the check connectivity Block 307 of FIG. 3. In Block 600, the installation and the qualification routine will first determine if there is a TCP/IP (Transfer Control Protocol/Internet Protocol) driver present. This will determine if the user has a ready connection to the Internet or is able to be connected to the eX-Mother server by the VSMS, if the connection is not turned on. If a connection to the Internet is available, the VSMS may automatically connect the user's modem to the Internet. If no TCP/IP driver is present then the required media player or TCP/IP drivers may be loaded from the BB BB by the VSMS. If no modem, DSL, Cable Modem, or any means of Internet connection is found, the VSMS can save all purchases made and may tell the user to install or connect a modem so that the purchases can be sent and sale items checked. However, the VSMS will also give the user the option of printing out his item checkout page and either faxing it directly from the BB or later, mailing or faxing the printout, or phoning the order to the merchant.

The pre-installation routine checks to see if there is a modem connected to the telephone line in Block 601. If a modem is present, then the user may complete the shopping experience by placing an order through the modem, if desired. Also, the system checks to determine if there is DSL service present in Block 603.

In like manner, the pre-installation software checks to determine if a cable modem is present in Block 605. If the cable modem is present, it may be preferable to send orders at the end of the shopping episode via cable modem over the Internet or at a more convenient or less congested time decided by the user.

Although the BB application is designed to be totally resident, the user may eventually want to transfer an order via modem to the merchant's server via the eX-Mother Server. Such a transmission might be accomplished using a system modem if present. In addition, some BB applications may ask the user if they want to have an update of their catalogue, or if the user wishes to see current sales, or even if the user would like to receive an affiliate's BB. Other BB applications will simply download all current data from the eX-Mother server and inform the user, for example, with a direct message on the user's display, of the current sales or updates.

An affiliate's BB could be received, for example, through the mail or through a download. Affiliate data may also be downloaded to the user system as a background task while the user utilizes the VSMS system to pursue an entirely local shopping experience. The VSMS may query the eX-Mother Server to see if updates to any affiliates or merchant pages are available. Instructions sent to the BB can cause the VSMS HTML page generator to create dynamic or static pages as required according to the nature of the shopping needs.

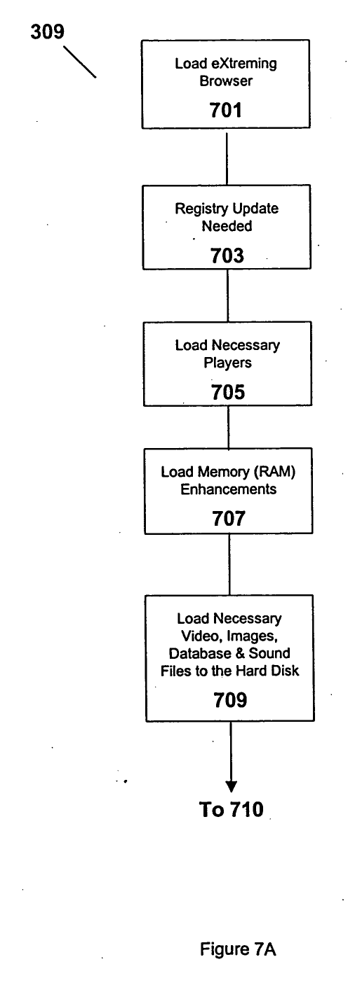

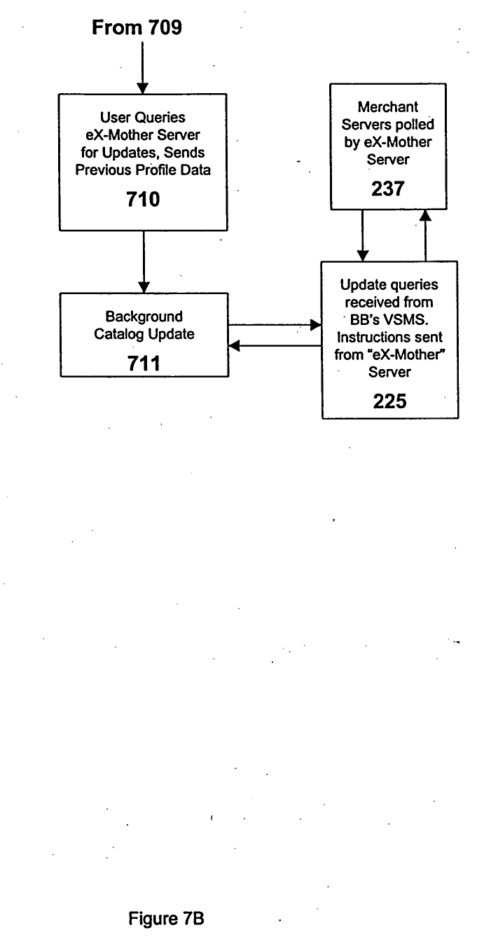

FIG. 7A is a block diagram that further describes the “load necessary software” Block 309 of FIG. 3. In Block 701, the eXtreming browser (eX-Virtual Browser), which is a custom VSMS Internet browser, is loaded on the system. The eXtreming browser (eX-Virtual Browser) is designed to optimize all files on the BB and work as an integral part of the VSMS server with the other files, which have been determined to be on the system, or which have loaded on the user system by the BB. In Block 703 the user's computer registry is examined. The purpose of this examination is to ascertain a default user name and to determine if any updating of the system parameters is needed. The user's name may be in the Registry, so a new BB may be able to greet the user by name. In addition, a previous BB may have stored user information, address, etc. elsewhere on the disk. (Prior credit card information could be accessed by password.) Storing information locally can eliminate much of the user entry needed to complete an order, thereby enhancing the user's shopping experience. In addition, a previous BB may have stored user profile information, Block 219, and stored the location into the user's operating system registry, as in Block 710.

In Block 705 the necessary players are loaded. The players that need to be loaded depend on several factors. The first factor being the VSMS application, which will be running on the user system. Some applications may require a type of player whereas other applications may require another type of player. In addition, players that are already loaded on the user system may not need to be loaded from the BB mass storage device.

In Block 707, any memory enhancements which are used by the VSMS are loaded. This may include the creation of such items as virtual disks or caches for graphic images. In Block 709, the actual application software is loaded. This may include, but is not limited to, video, graphic images, databases and sound files. These files are loaded from the BB mass storage device, in the present exemplary embodiment a CD ROM, to the user's hard disk. Files which are stored on the user's hard disk may incorporate files.

In Block 710, the user's VSMS may query the eX-Mother Server for updates. Product updates received from a merchant by the eX-Mother Server provide directions to the Product Update HTML Engine, also known as the automatic shopping page generator/engine section of the VSMS. Block 711 represents a background task such as might be used to update the VSMS software with the latest sales, catalogue items, etc. Some applications may have the facility to quickly download sales and new items from a remote server while the user is utilizing the VSMS server for shopping.

Except in instances in which the BB links to a remote Internet webserver not operated by the eX-Mother Server, all communication from the BB will go to and throuhg the eX-Mother Server. Preferably, all communications to BB merchants emanates from the eX-Mother Server.

The VSMS may use its automatic HTML page generator which generates the respective new or “on sale” shopping cart HTML pages which are created from instructions received by the eX-Mother Server. The eX-Mother Server receives these updates and provides them to the BBs by, for example, polling merchant's Internet webservers, accessing previously configured databases, translating this data, and then directing each BB system to update its pages accordingly. Additionally, the Product Catalog File is updated to allow further searches and ability of the E-Commerce engine to select the new products. All of these actions preferably occur seamlessly and invisible to the user, who may only be aware that his or her modem turns on for a few seconds and-then turns itself off. Graphics for certain “sale” items or products, in anticipation or in coordination with the merchant's sales strategy, may already be stored on the BB, as would be the HTML page creation template, so that at the merchant's expected time or duration, users existing BBs would provide the user with the latest sale prices.

This form of communication between the BB software system, eX-Mother Server, merchant and return communication to the BB (in the case of credit card approval or disapproval for purchases) preferably occurs by way of small data packet transmission instructions to and from the BB software system. No HTML or graphics images need be uploaded or downloaded, so the updates and credit card approvals may occur in mere seconds, or less, and do not interfere with the user's shopping experience.

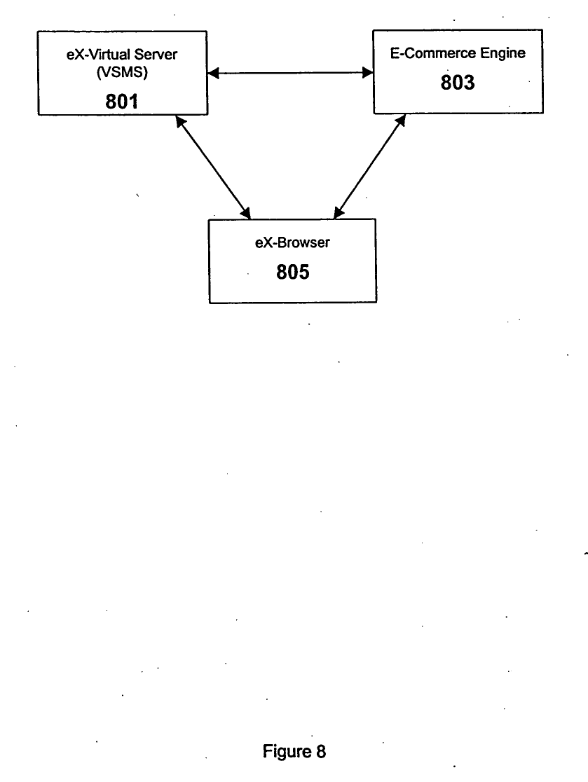

FIG. 8 is a simplified block diagram, which illustrates a BB VSMS system loaded to and running on a user's computer. Utilizing examples and embodiments of the present VSMS BB system loaded on a user's computer, the user can participate in E-Commerce without external connections to the user's computer. Utilizing the BB software a user may participate in E-Commerce even when no telephone, modem, or Internet connection to the user's computer is available. For example, an airline traveler on a long airline trip may utilize a laptop computer to shop from the traveler's seat. The order may then be sent later, for example, when a connection such as a telephone line is available. Users may even use the airline telephone to send their telephone orders. Using conventional processes of interacting with a remote website, it was difficult and expensive for a airline passenger to participate in E-Commerce while traveling on an airline. This is because the telephone connect time an airline is extremely expensive. In addition, because the telephone connection may or may not be as good as a land line connection a computer connection to a website via an airline telephone might have to operate at a lower speed to be assured of reliable data transmission. Speed would merely exacerbate the delays experienced during a normal E-Commerce shopping experience.

By using embodiments of the present invention, a user could enjoy a high quality E-Commerce shopping experience with virtually no delays. Even while traveling on an airline, a user could shop throughout the day, for example while traveling on a plane, at a hotel room, while waiting for meetings to begin, or even during a meeting. The user might also engage an automatic window-shopping mode, where the user is taken on an overview tour of the BB contents automatically (i.e. no user interaction required).

As illustrated in FIG. 8, the eX-Virtual Browser 805 communicates with the VSMS, just as a normal browser would communicate with an E-Commerce server site. Since the eX-Virtual Browser 805 and the VSMS 801 are resident in the same computer system, the transfer of data is seemingly instantaneous. The eX-server 801 also communicates with the E-Commerce engine 803 that in turn communicates with the eX-Virtual Browser 805. The E-Commerce engine 803 provides for the normal E-Commerce function, such as searching for products, tracking purchases; placing items to be purchased in a virtual shopping cart providing forms for entry of shipping addresses. In some preferred embodiments of the present invention, the E-Commerce engine may be used for tracking shopping experience behavior.

Although FIG. 8 portrays a BB system, distinctions between the parts of the system are mainly for descriptive purposes. The software is actually an integrated application. Because the software is an integrated application intended to be run on a single host system, it can be made to be highly reliable. It also does not have to cope with incompatibilities between browser and web page files, since they were designed to be compatible.

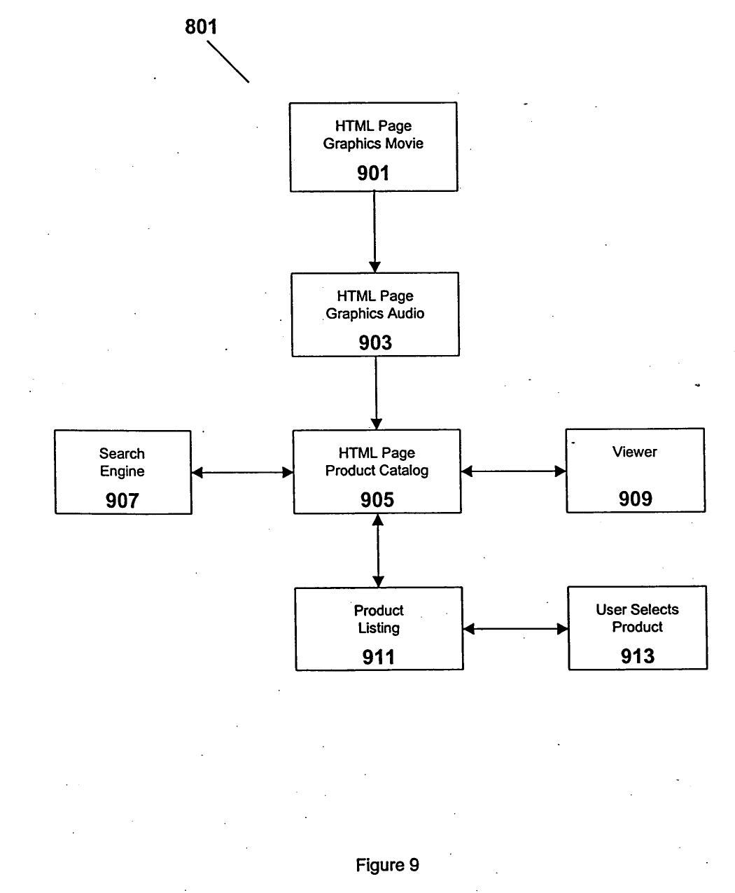

FIG. 9 is a block diagram expanding on the functionality of the VSMS 801 in FIG. 8.

FIG. 9 is a elaboration on the VSMS functions as shown in Block 801 of FIG. 8. The VSMS may provide html page graphics including a video file as shown in Block 901.

The VSMS may provide html page graphics and audio as illustrated in Block 903. The VSMS may provide an html product catalog 905, which may then further interface with a search engine 907 for searching of the html product catalog 905. A product listing may be used for thumbing through the product catalog. A product listing may contain numerous pages of products shown in thumbnail size. The user may jump between product pages just as a user may thumb through a paper catalog and can 913 different products as in Block 913 in order to expand the thumbnail image within the viewer 909.

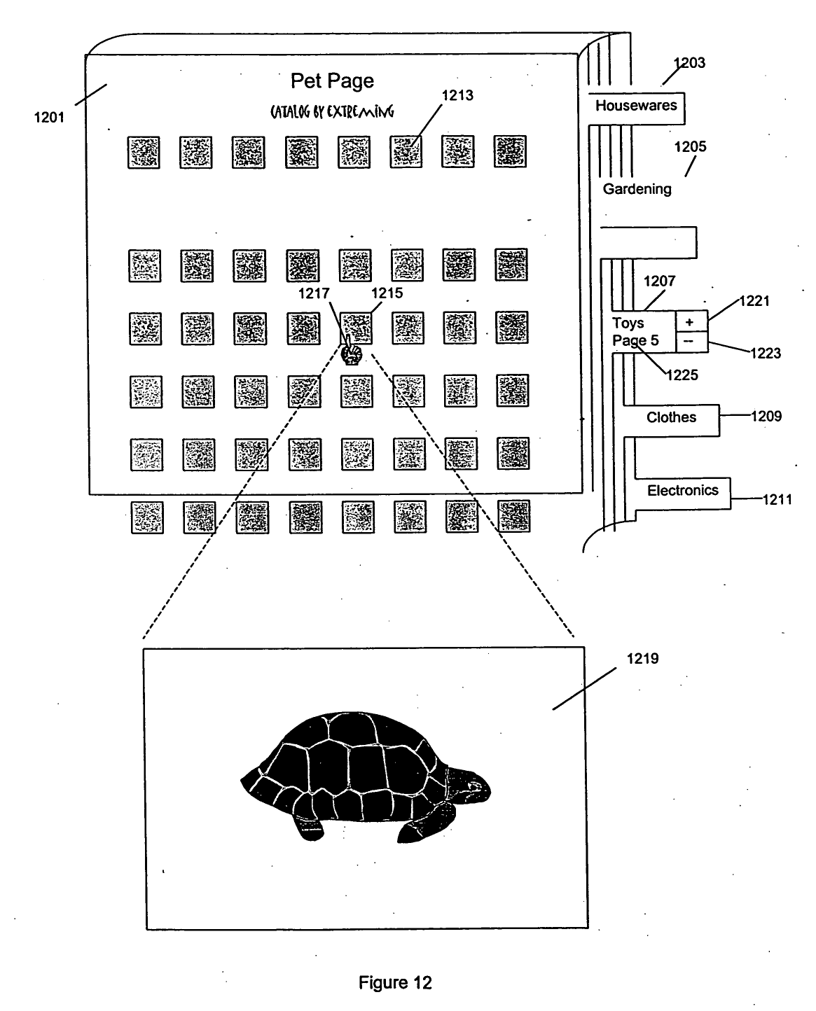

FIG. 12 is a graphical example of an exemplary BB catalog. In the illustrated example, the catalog is represented on a web page by a display resembling a paper catalog 1201. The display catalog 1201 has a variety of tabs corresponding to different product categories, for example, in a department store, where housewares is 1203, gardening is 1205, toys is 1207, clothes is 1209 and electronics is 1211. The page representing the pet department is currently displayed. By clicking on a tab, the page corresponding to the tab is displayed. Currently, the pet page is being displayed. The pet page comprises a number of thumbnail graphics 1213 representing pictures of different pets. The user chooses the image they want to have enlarged e.g. 1215, using a common selector mechanism 1217, such as a mouse cursor, and activates it, for example by double clicking the left button of their mouse. Thumbnail 1215 is activated and displayed in the picture 1219.

In addition, tabs may be subjected to multiple clicks in order to display multiple pages. For example, the toys tab 1207 may also have a plus (+) 1221 and minus (−) 1223 graphic on its tab for allowing a user to select other pages either after or before the currently displayed page. By clicking on the “+” the user is shown the next toys page in a sequence of pages. Once the user has reached the end of the toys displayed, the plus (+) symbol 1221 may be grayed out. The user may also activate the minus (−) sign within the tab 1223. By doing so, the pages of the virtual catalog are then advanced in a direction opposite to direction advanced by the plus tab 1221. Additionally, the toys tab may have an insert such as 1225 with a page number indicating the current page being displayed. Not only will this provide a visual cue of where the user of the catalog is browsing, but it also provides a convenient way to identify and reference the different pages. The visual arrangement display in FIG. 12 is merely an example of the type of displays that may be effected utilizing the inventive concepts disclosed herein.

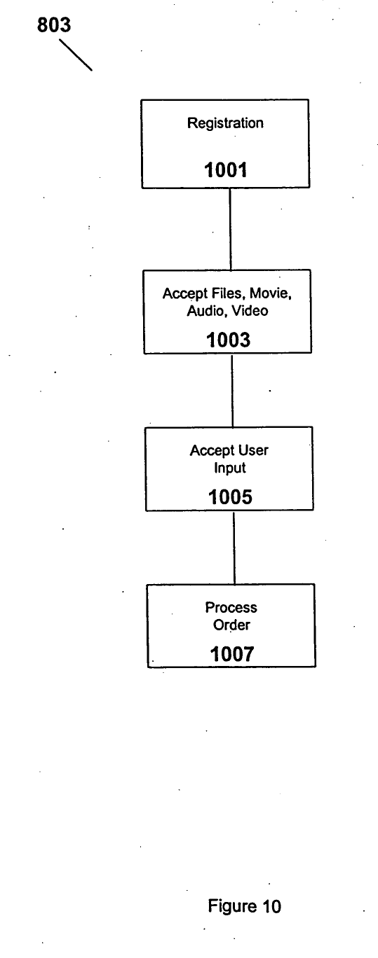

In addition, the product listing function may be used in concert with the shopping diary functions 1113 as will be discussed herein. FIG. 10 is a further illustration of functions of the E-Commerce engine 803 as illustrated in FIG. 8. The E-Commerce engine may provide for a registration of the user 1001. Registration could include, for example, procedures for a user to input user information such as name and address, payment information, for example a credit card or debit card to be used for purchases. In addition, the E commerce engine would accept html files, movies, audios and videos as in Block 1003. This data could also be used to illustrate or compliment product descriptions.

The E-Commerce engine also accepts user input 1005 in order to perform focused searches, place items in shopping carts, begin the checkout process, take items out of shopping carts, estimate shipping costs and the like. Original product data can be stored in a Product Catalog File and accessed by the E-Commerce Engine to deliver shopping cart products and perform focused searches. E-Commerce engine 803 may also contain a facility to process orders 1007. Orders may be completed, for example, when the database engine uses the modem within the user system to communicate with the merchant's remote server via a dedicated 800 number. Using such a scheme, both merchant and the customer-user may participate in an E-Commerce transaction without an Internet connection and without privacy risks that accompany transactions on the Internet. The order processing might also involve the packaging of an order along with approved credit card information 1111 and the sending of the order data and credit card data to the merchant via the eX-Mother Server on the Internet.

A possibility for completing orders is that the user may, after completing an electronic shopping experience, choose to print out a order on their computer's printer and place the order in the mail or send by facsimile transmission.

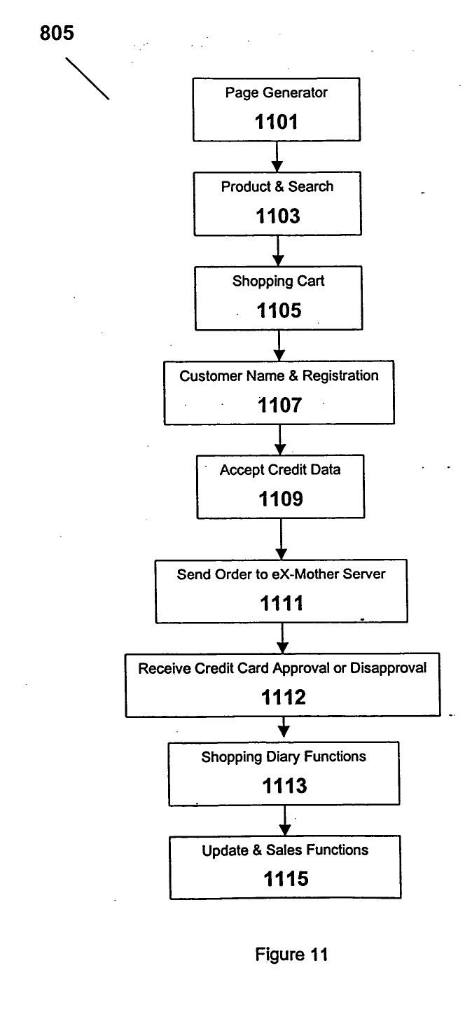

FIG. 11 is a further description of the typical functions of an eX-Browser 805 as shown in FIG. 8. The eX-Browser may perform the normal browser function of accepting and displaying HTML files and shoppable web pages generated by the VSMS 1101. The VSMS also produces pages to be used for information and products searches 1103 as well as provides for a shopping cart for purchases 1105. Additionally, the VSMS can generate shoppable HTML product update and sale item pages. When the eX-Virtual Server (VSMS) queries the eX-Mother Server regarding available product sales or product updates, instructions are sent to the eX-Virtual Server (VSMS) operating on the BB.

The HTML Page generator function of the VSMS may then use the instructions sent by the eX-Mother Server to generate pages.

The eX-Virtual Browser accepts customer name and registration 1107, credit card data, 1109, couples the information into the E-Commerce engine 803, and assists in sending orders 1111. In Block 1112, the eX-Virtual Browser sends the order for credit card authorization to the Ex-Mother server. The Ex-Mother server then obtains appropriate approvals or disapprovals from a credit authorization company, preferably as an on-line communication with the credit authorization company or sent directly to the merchant for processing. In either case, a verification message is returned to the E-Commerce Engine 803, to cause the E-Commerce engine to generate a message to notify the user of whether the credit card has been approved or disapproved.

In addition, in using the eX-Virtual Browser, shopping diary functions might be activated. Such diary functions provide advantages over print catalog type shopping. By using the shopping diary functions, data about items that the user has displayed is recorded, as well as how long they were displayed, how many times the user returned to those items and whether the user actually ever placed one of those items in a shopping cart.

To use a common paper catalog, a user usually thumbs through the entire catalog, observing pages sequentially or randomly to determine if any of the items within the catalog are of interest. Sometimes a user will compare several articles found in the catalog in order to decide which item is the most appealing. A user may compare description, pricing and variety of other data associated with the item which the user is considering purchasing and may return to the same page to consider the purchase a number of times. Using the diary function of embodiments of the present invention, a user may similarly thumb through images provided as an electronic catalog within a BB system several times. The user may then activate the virtual shopping diary, which loads local profile history 219 at a later time, and review which items or product pages have been previously viewed.

A common behavior, when browsing through a print catalog, is to mark interesting items, for later consideration. Paper pages have been marked with bookmarks, the end of the pages folded, small tape tabs appended to the pages or a variety of other ways of “saving” a page for later reference are commonly used. A BB Interactive Media Site E-Commerce System also provides a user with many different ways of refining their product search. The user's product search may be greatly assisted by the BB electronic diary function, called a Virtual Shopping Diary. By simply bookmarking the pages of interest, the eX-Browser's bookmark function creates a virtual store which just contains the user's shopping history.

By accessing the shopping diary 1113, a user can see a display of all previously bookmarked items in the same sequential order as they had been displayed previously or the order may be rearranged dynamically by category, number of times the page was displayed, or a variety of other criteria. In such a way, the user could quickly find items that had previously drawn the user's interest. This shopping diary data may be recorded for future use on the user's hard disk. If the user only traverses the catalog without making any purchases, the diary's contents may also be sent to the merchant via the eX-Mother Server during the session, or when the user next logs on to the Internet (if the user removed the BB before the VSMS had a chance to open up a TCP/IP channel) and relay the information to the eX-Mother Server.

The eX-Mother Server may keep track of all incoming data for customer profiling related to the inherent products and cumulative data mining and product profiling, all of which will be tabulated and sent to the merchant.

Whenever another BB Interactive Media System containing different products is placed in the user's local computer host device at a later time, the VSMS eX-Virtual Server may read earlier shopping diaries recorded in small files on the user's hard disk. If profiling criteria is appropriately found the VSMS will dynamically deploy pre-loaded products and shopping pages according to the pre-defined, ACTUAL interests of the current consumer, rendering the user's shopping experience more personal and direct.

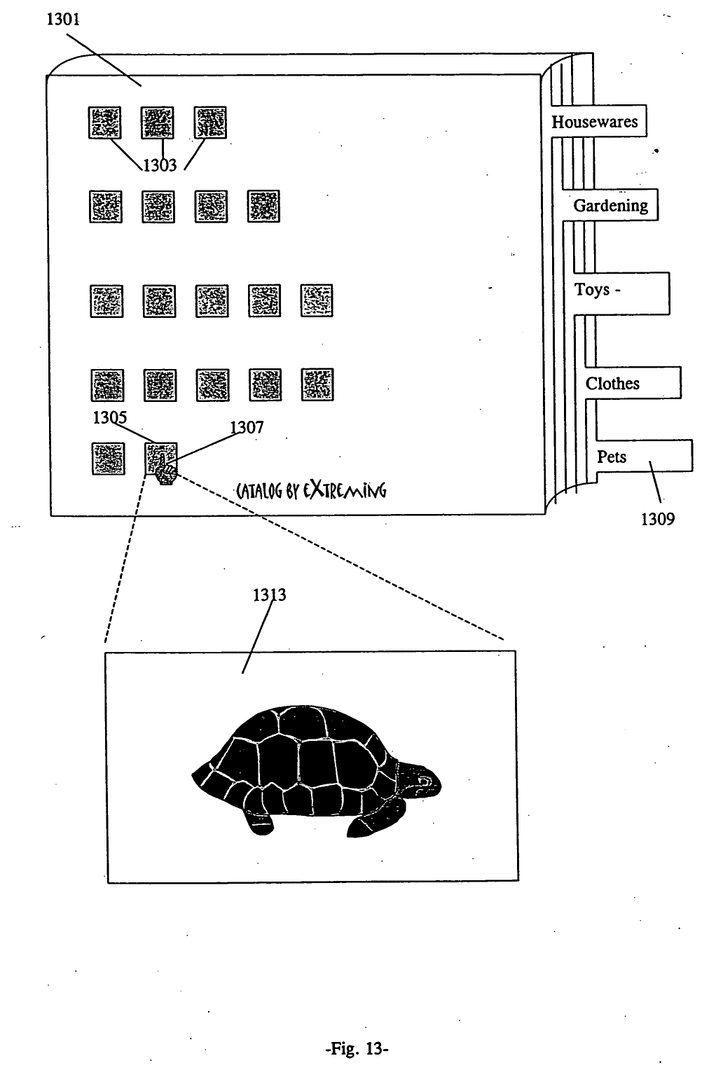

The Virtual Shopping Diary may be used to produce a display such as illustratively shown in FIG. 13. In FIG. 13, the catalog 1301 is once again displayed with thumbnail displays, such as 1303, arranged in conjunction with the different subject tabs. The thumbnails represent displays of items in the catalog that had been accessed by the user. The thumbnails could be placed in such an order as to indicate which items the user was most interested in. A user's interest could be determined by a variety of different methods. For example, a user's interest might be determined by how long a particular image was displayed on the user's screen. Another metric that could be used to determine the catalog user's interest would be to determine how many times a user visited our particular image. Thumbnails of the images that had interested the user could then be displayed on the shopping diary data display 1301. The user could then revisit any image, such as 1305, by selecting it with a pointer 1307 and activating that thumbnail image. Once the user activated the thumbnail image, for example by clicking on it, a larger version of the image would be displayed. In the examples shown in FIG. 13, thumbnail 1305 is selected by pointer 1307. When the user activates pointer 1307 by clicking the mouse button or by entering a return key, the image 1313 that the user had previously viewed is displayed.

A user could also use the same type of display to display items in the user's shopping cart. Because all the items are resident on the user's system, there will be very little delay between the time when a user clicks on a thumbnail image and the time when the full size image is displayed. In contrast, this type of display mechanism may be far less attractive when used with an Internet connection because there might be considerable delay while the full size images are sent from a remote server. When a user clicks on a thumbnail, a larger image must be brought to the screen. If the larger image is retrieved from a local source, such as a CD ROM, RAM, or a hard disk drive, the image may be displayed relatively quickly. Also, a succeeding image may replace the initial image quickly.

However, if the images must be delivered over the Internet, the image must be first requested by the user, which request must then be transmitted over the Internet, and finally received by the remote server. The server must then access the image and communicate it back across the Internet to the user. The delays inherent in such a system could severely limit the technique's usefulness.

No such delays, however, would be noticed in a BB type application, because all of the images and thumbnails can be stored locally on the CD ROM media of the BB located on the user's computer host device.

Adaptations of the BB and the shopping diary could be used for many other purposes. For example, a young couple about to be married might bring home a wedding BB containing such traditional items as silverware, linen and crystal. The couple might then shop through the catalog clicking on the items that were of interest to them. BBs containing the shopping diary could then be sent along with the wedding invitations, in order to make the wedding gift giving process much easier. The wedding guests would only need to select an item on the BB and then order it. The ordering could be done by any of the previously discussed mechanisms of BB ordering. Shopping diaries could replace “wish lists” in other situations such as birthdays, anniversaries, Christmas or other gift-giving occasions. Services, such as gift-giving, could be easily implemented using the BB and the shopping diary data.

In addition, this shopping diary data may be provided to the merchant for the purpose of improving catalog delivery or for targeting the user for further BB application disks. All Virtual Diary bookmark entries, all pages viewed, as well as all items which were displayed for the longest duration of time or the items which were displayed the most number of times (or displayed for a period of time or number of times above a preset threshold period or number) provide the merchant with resources for targeting customers. This information may be sent to a merchant at the time of an order or it may be sent to the merchant the next time that the user logs on to the Internet. The Manager of the BB electronic catalog application would then obtain data from the users of their BB catalog in order to refine their presentation. The merchant may also use this user information to target different updates and sales to the current user, as well as placing them on a list to receive future BB mailings.

An additional application of the Virtual Shopper's Diary enables the BB to provide real time anonymous customer profiling data online to a merchant data may be sent to the eX-Mother Server and merchant can see in real time how the BB catalogs are actually being used and which products are being purchased. This data can also be recorded and used to provide the merchant with a time line of BB sales.

The update and sales functions 1115 in FIG. 11 may also be a feature of the eX-Browser. By selecting these functions, or by having them run automatically, the catalog could be quickly updated from a remote server with the new items and sales items. An update function could occur as a background task while the user is using the BB application to shop normally or if the BB system was using its deferred ordering function. Sales displayed may then be triggered if the user showed that there were interest in a certain type of product of which a sale was currently being held. The user might also be updated concerning new models and new items available of the type in which they are interested. These functions could take place transparently and in real time in an Internet connected scenario while the user is pursuing an E-Commerce experience or automatically, when a delayed order was being sent to a BB E-merchant. Such updates and sales functions may be integrated seamlessly so that they did not affect the shopping experience. In other words, while a user was looking at some product images, the computer could be in the background receiving additional data on new products within the areas in which the user had shown interest or while processing a delayed order.

In a preferred embodiment a BB Interactive Media Site has an automatically catalog update function which occurs in the background the moment the BB is inserted into the user's host device. The VSMS (eX-Virtual Server) can use an existing online connection or establish its own TCP/IP Internet connection in order to query the eX-Mother Server and update itself.

If there is no Internet connection detected the VSMS may allow the user to commence shopping but save all purchases made and may tell the user to install or connect a modem so that the purchases can be sent and sale items checked. Alternately, if no modem is present, the VSMS may give the user the option of printing out his item checkout page and either faxing, mailing, or phoning the order in to the merchant.

Those skilled in the art will realize that the embodiments of the presently disclosed system may be varied to tailor them to individual application needs. BB marketing may be tailored to individual customers. For example, customers who received a printed seed catalog for gardening purposes may be sent a BB on gardening supplies to use with their computer. Additionally, BBs may be tailored to individual consumers. For example, if a user fills out a information request card, such as is often done to request information in magazines and periodicals, the information may be used to send the user a CD ROM containing several BB applications, that is several stores upon the same BB. The person may then shop from the electronic stores on the disk, which carry products in which the user has already shown an interest. This may provide advantages over the current E-Commerce systems in that, instead of having to switch websites in order to access products from several different stores, the user may switch between virtual websites, i.e., different stores contained on the same BB, with virtually no switching latency.

A BB method of direct electronic marketing in addition to providing improved electronic catalog shopping experiences, which improve over the paper catalogs received in the mail, may provide other types of advantages. One of the other types of advantages is that several stores (for example, multiple different merchants) may be provided on a BB medium such as, but not limited to, a CD-ROM or even a DVD ROM. DVD ROMS, because of their large capacity, may even provide an electronic mall experience. A user may electronically window shop through multiple stores in an electronic mall and, once the user has found a store containing items of interest, the user may electronically enter the store. Because all of the data and control for the electronic stores are contained locally on the user's computers, the user may window shop rapidly from one store to another, with no delays as would be encountered if the user had to access different websites in an on-line Internet environment.

Some of the new types of shopping experiences enabled by the BB method of commerce are enumerated herein. Another method of using the inventive principles disclosed herein is to use the BB storage medium, for example a CD-ROM, to store the large files, which were associated with a remote Internet website and would produce the greatest delays. For example, large graphic files could be stored on the BB and transferred to the user's hard disk as needed, or may be loaded directly from the CD-ROM by the VSMS while still in contact with a remote Internet website, instead of being transmitted and retransmitted across the web. This could enhance an on-line website experience by providing data intensive applications, such as showing video clips, on the CD ROM. Data intensive techniques are often avoided by web designers because of the inherent delay in transmitting the files between the web server Internet and the user's host system. A BB Interactive Media System CD could supply those advanced techniques, while the usual load data commands and prompts may be sent back and forth over the Internet. In such a manner the largest bottleneck (i.e., the transfer of large files from the host website to the user's PC) could be eliminated. Advanced techniques for displaying products and information could then be utilized because of the reduced data transfer requirements.

In another application of BB VSMS technology in conjunction with an active Internet website, a full media-rich interactive electronic mall may be facilitated. A user may navigate the electronic mall which may comprise basic HTML and minor graphics files, but, with the BB software application, being able to launch full screen videos and large format graphics using video methods such as a Xing™ Player, Flash™, QuickTime™ or Shockwave™ or even the standard Windows Media Player™ supplied with MS Windows 98, 2000, or NT. Using such graphics and/or video display methods a user is able to simulate a walk through the mall by displaying store fronts in a mall environment. A user may then select a storefront by clicking on it in order to enter that store. A user may then select large graphics files of products or view video product commercials in order to see or purchase the products they are interested in. To accomplish the exact same application over an on-line Internet connection would involve streaming a large amount of video data and thus making it difficult to perform E-Commerce shopping or even normal Internet browsing. However, if the video and graphics files are launched locally (i.e., present on a BB application and hence run locally on the user's system), the files needed could be loaded from a high capacity media such as a BB on a DVD (Digital Versatile Disk).

Additionally, the Mall website may actually run the BB's media content from CGI or other programming instructions inside of the pages which reside on its merchant website Internet server and are called up by the BB from the user's local host device (PC). The website Internet server could then send commands to display various files from the BB DVD locally on the user's host system representing other portions of the Internet store or the E-Commerce shopping cart and checkout portion of the store. The user may then shop unassistedly from a BB application, unaware that what he is seeing is the results of a hybrid Internet application. If some new information is desired, such as information regarding new products which have been recently received, products which are on sale, if an item is back ordered, or other promotions within the store, the merchant's Internet Website server could receive the request for information in the background—by sending and receiving update instructions from the merchant's site via the eX-Mother Server the VSMS may create new pre-programmed pages which could request graphics and video files from the BB concurrently inserted into the user's host device to display. (In such a case the “Client” in traditional terminology, has now been temporarily transposed into a “Client/Server/Client” and the “eX-Mother Server” has been transposed into a “eX-Mother Client.”) A user could even be told that new sales items are about to be downloaded to the their host device while the user is using the BB E-Commerce system, in order to give the user the latest and best prices.

Another application of the BB technology is deployed by having a BB control a merchant's remote Internet server from the user's host device, with or without the need for an eX-Virtual Server or VSMS. In this scenario, there might not be a VSMS server on the BB, but the BB would contain just enough programming and pre-programmed web pages or programming executable to show all media content and send instructions to the remote Internet server to perform E-Commerce and credit card approval, then “returning” the user back to the Interactive. Media Site existing on the BB The user will not be able to tell the difference or notice that an external website provided the “background” shopping cart, etc.

In this type of application, the BB takes actual control of the merchant's remote website server. A VSMS (eX-Virtual Server) may not exist on the BB; however the BB contains pre-programmed (CGI, Java, PHP, etc.) HTML web pages from which instructions are sent or posted to the remote server. The remote merchant server assumes these instructions are coming from a “visiting client” machine on the Internet when in fact they are being sent by the eXtreming web pages on the BB software. Thus the “Client-Server” relationship normally found on all Internet applications is reversed by the specialized instructions originating from the BB and completed by the merchant's remote server, in effect, turning remote servers into a “client.”

Another application of the BB technology allows for use of the HTML Web Page Update or Generation engine (as previously outlined) to be used to create a dynamic, perpetually updating, Merchant and Affiliations Advertiser's Page. As the BB is installed into a user's local host device, it may, either in the beginning of the shopping process, or at any time during the process, and as many times as needed during the process, request or send instructions for any of its operations, to the eX-Mother Server. At this time the latest merchant's or advertiser's or affilliate's internet link information is sent to the eX-Virtual Server on the BB. The eX-Virtual Server may then assemble a dynamic (existing in memory only—not hard coded or physical) HTML page or may create a hard coded HTML page on the user's local hard disk storage media. Merchant advertisers or affiliates graphics may be pre-loaded already on the BB. In this way dynamic, or “on-the-fly” HTML web pages with the latest advertisers and their links may be displayed to the current BB user, regardless of when the user installs the BB into his local host device.

Another application of the BB technology may be called “BB-Internet (BBi)” and can be realized by having the eX-Virtual Server on the BB act in tandem with a merchant's existing remote website's Internet server. With BBi technology, all HTML pages reside on the remote website's server, but all graphic files, large video files and searchable Databases are located on the BBi CD ROM, and operate from the local user's host device. (FIG. 14) The user inserts the BBi CD ROM into his local host device and the eX-Virtual Server located on the BBi CD ROM activates or loads the user's default Internet browser. If the user is not already online, the eX-Virtual Server initiates an internet connection, as previously defined as standard BB activity.

The eX-Virtual Server intelligently causes the user's default browser to locate the merchant's remote server's Internet website, concurrently sending the electronic address or HTTP Internet Protocol (IP) address of the calling BBi of the user's host device. On the merchant's remote Internet Server website there is a software program waiting to receive the BBi's HTTP IP address as well as other instructions or directions as to which website pages to load or which place or part of the website store to start the visiting user.

The receiving program specified here on the remote Internet server's website is a portable or compiled software version of the eX-Mother Server (called here an eXP-Mother Server). (FIG. 14) As the user browses a remote website, the remote eXP-Mother Server sends web pages with pre-programmed instructions to the local user's BBi to load all graphics and video files, as well as do database searches or perform all database needs as required or requested by the user visiting the remote Internet web site through his browser.

In this type of application, the BBi and the eXP-Mother Server program on the remote merchant Internet server (FIG. 14) actually share control of both the merchant's remote website and the user's host device's browser, where the BBi CD ROM is currently installed. The remote Internet website is built by the merchant and contains the majority of HTML website pages being viewed, however these HTML pages contain embedded, pre-programmed commands from a language by which the eXP-Mother Server communicates with the eX-Virtual Server on the user's host device. This language is called “Virtual Server Markup Language” or “VSML.” These embedded commands instruct the eXP-Mother Server to load the requested internal website HTML pages as well as coordinate the posting (locate and sending of) instructions to the originating BBi's software, or eX-Virtual Server. These instructions are received by the BBi residing on the user's host device by linking back to the IP address originally given by the BBi, then sends instructions as to which graphics, video files, or database searches to perform, completely coordinated with the answering remote server. What the user actually sees is the composite of both actions of the eXP-Mother server loading the website's HTML pages, and the graphics, video files, or database searches being controlled by the eX-Virtual Server on the local BBi.

These actions happen exceedingly fast since everything but the remote HTML web pages are loaded locally from the BBi CD-ROM user's host device and, where possible, may be pre-loaded into RAM memory. The user's Internet shopping experience is heightened by the fact that all files and database activity do not have to be transferred from the remote server across the multiple nodes of the Internet, to arrive at the user's host device. Additionally, the user is able to experience video media which would not have been possible or feasible loading from the website.

Additionally, the merchant's remote internet server website is freed from excessive bandwidth usage. For example, many people doing file downloads and loading graphics as well as database file access searches, thousands to hundreds of thousands at the same time, accessing the same Internet server simultaneously. All these activities normally have to be accounted for in building Internet server website hardware and software to accommodate the cumulative needs of each user who comes online. The lessening of physical bandwidth requirements and allocations needed for each visitor may allow an Internet server website to safely accommodate multiple amounts of new or additional shoppers on the same server or website without increased costs for adding expensive new Internet server hardware.

When the BBi initially links to the remote Internet server, the remote Internet server assumes the instructions or requests originating from the BBi are coming from a “visiting client” machine on the Internet. The remote server allows itself to pass control to the residing eXP-Mother Server software. However, when the eXP-Mother Server takes over to load or serve HTML it also turns itself into a “client” device and communicates back to the calling BBi's eX-Virtual Server on the user's local host device. The eXP-Mother Server now requests the BBi to “serve” all graphic, video, and database functionality to itself. Thus the “Client-Server” relationship normally found on all Internet applications is again reversed by the specialized instructions originating from the BBi and completed by merchant's remote Internet server, in effect, turning remote servers into “client/server/clients.”

There are, therefore, a variety of intermediate applications which range between an electronic commerce shopping experience such as might be produced by a BB E-Commerce system and a dedicated connection to a website. BB These would all be intermediate steps between current E-Commerce and full BB E-Commerce. A major difference between hybrid and full BB commerce is that, in full BB commerce, the VSMS is of course supplied by the BB storage media and runs entirely on the local machine without the need for an online connection except to receive authorized credit card approval. The eX-Virtual Server is then resident along with the entire application on a pure BB E-Commerce application. In a hybrid application between pure BB commerce and current E-Commerce, a merchant's web server could be used to only provide the CGI functionality for adding up purchases, calculating tax, receiving credit card information etc. Only that type of information need be transferred. In such a hybrid BB E-Commerce application, the access speed could be increased considerably as well as increasing the quality of the shopping experience. The hybrid BB may require the user to be online during most of the activity, but it would provide a much faster interactive experience than accessing a conventional website to purchase products because graphic intensive operations are still resident locally on the BB.

By utilizing the BB method of Virtual Streaming Interactive media E-Commerce, there are a variety of ways that revenue may be generated.

A first way in which the BB may be used to generate revenue is to charge a transaction fee to the merchant who received purchases from a BB transaction. IP Merchants would be approached and asked if they wish to have an interactive media site on an upcoming BB mailing or a future BB distribution. Distribution might take any number of forms, for instance a direct mailing, giveaways in stores, or in response to inquiries. The merchant could pay the costs of manufacture and distribution. Once the store had been created and manufactured for the merchant, the BB could then be distributed. Once distributed, the merchants may be charged a percentage of each sale that had resulted from the BB, the merchants may be charged a fixed amount per sale, or by the number of individuals who had made purchases. The purchase statistics would be accessible because sales would either go through the eX-Mother Server, or the information could be accessed or a special code may be added to BB orders which were mailed, phoned or faxed.

In another version of this revenue model, the producer/issuer of the BB media could essentially market to a merchant the ability to provide the merchant's store on a disk for a percentage of the sales, which were achieved using a BB system. Since the BB is producing a sale that would not have existed otherwise, a sale not related to the brick and mortar site, a BB sale may be a highly profitable type of sale to a merchant. Because of the profitability and because of the no up-front cost to the merchants, the business model of producing BBs for stores at no cost in exchange for a percentage of sales, may produce considerable revenue for the BB producer/issuer.

A second way in which the BB may be used to generate revenue is from a license fee, which may be charged according to the number of BB media distributed. For example, a specified amount, above the costs of producing the BB and the mailing, could be charged for each BB mailed.

A third method of generating income is through an affiliate program. In such a program affiliates may be charged a fee in order to have their URL appear or a commercial appear when a person has signaled that they wish to close their BB shopping episode. For example, a person leaving a BB electronics store, where CD music players are on sale, might have an advertisement appear to purchase CDs or order a BB CD catalog. Affiliates might also pay fees to have their stores, or perhaps an abbreviated version of their stores, available within the BB application. With a preview store of an affiliate being shown to a user, the user then may signify a desire to receive a full BB store, for example, on a CD in the mail. Such a system would generate leads for the affiliates and income for the primary BB merchant.

In another method of receiving affiliate income the BB's could include affiliate merchant's commercials, banner ads or other advertising embedded on a BB. Such ads, when viewed or accessed by a user, could, at the user's option, link the user to the affiliate merchant's Internet website. The affiliate merchant would pay the BB's issuer a “click through” fee and/or a fee for any transaction made by a user who links to their site via the BB.

A fourth way in which a BB may be used to generate income is to provide targeted ads to users that merchants would pay a fee for as a further advertising service. For example the BB service provider could examine a BB user profile from the user diary, or one present on the eX-Mother which had been accumulated for the user. If the user profile indicated an interest in a certain type item, an interactive advertisement provided by either the same merchant or another could then be downloaded to the user's system. Once the advertisement was downloaded the advertisement could then be activated. The BB issuer could provide these targeted advertisements for a fee to merchants. In addition, responses to the ads could be analyzed in light of the local user profile and the shopping diary. Information from this analysis of purchasing demographics then could be provided to the merchants for a fee.

A fifth way of generating income could be to provide BBs, which generally do not sell anything, but instead are used to examine consumers responses. For example, an automobile manufacturer could provide a BB through a mailing. The automobile manufacturer might show pictures of its cars, horsepower ratings, prices, etc., etc. The user could then view the disk once or several times and after it had been used for a predetermined number of minutes or views, the user may be prompted to link to a standard online website of the automobile manufacturer in order to receive a promotional discount or sales pitch. For example, a user might be prompted by incentives to link to the local dealer for the automobile manufacturer for promotional considerations. For example a user could be informed that, by logging into the local dealer and accessing their website, the user would receive a free set of car mats, a free window tinting or some other promotional item if they purchased their vehicle from the local showroom. In addition, to the leads being provided to the local car dealer and charging for that by a variety of methods such as a fixed amount per lead or a fixed percentage of the amount of purchase. In addition to those methods of creating income from the site, data could be gathered on how the user used the BB, including, for example, which images did the user displayed, which videos the user viewed, which items the user spent the most time on, which were most frequently accessed, the order in which the BB is accessed and a variety of other useful marketing information. This information may be sent to the merchant (through the eX-Mother Server) even if the user does not immediately purchase any product.

In addition a shopper's diary, which had been recorded on the user's host device may be a source of revenue. The shopper's diary may contain valuable information about a purchaser's buying habits, especially with respect to the BB. The shopper's diary may be uploaded at the time of a purchase being made via the BB Such an upload could be used for statistical purposes, for example, to find out which BB products or pages are most and least popular. Such information may be used to later enhance customers appeal of BB systems and their offerings displayed therein by delivering targeted advertising based on the feedback received from individual BB users/customers or groups of users and customers. Merchants may be charged, based on the type and quantity of information the BB delivered to users and merchants alike.

A further application of the Shopper's Diary enables the BB to provide real time anonymous profiling which gets sent to the eX-Mother Server so that a merchant can see how the BB catalog is actually being used and which products are being purchased in the field, right from the commencement of a BB activity.

Another way of realizing revenue from the BB is by providing an e-mail facility which would e-mail orders to a merchant. A fee could be charged per e-mail. Another method of providing revenue generation from a BB is by allowing affiliate click-throughs, for example, on the final screen of the BB shopping experience. Each click-through that resulted from a BB could be recorded and used to determine fees to be paid the owner of the clicked-to site.

Although the applications discussed involve a computer user and a BB application other BB platforms might also be employed. For example, a BB application could be utilized in a video game machine or bidirectional cable set top box. A bidirectional cable set top box user may watch a home shopping channel and indicate, by pressing a button on a remote control, that the user is interested in products from the manufacturer who was currently displaying products on the television. A signal then could be generated in the bidirectional cable set top box in order to send a signal to a cable head end (cable operator), which would then cause the downloading of a BB application. The next time the user turned on the television, one of the menu items available from the bidirectional cable set top box may be a link to go shopping using a BB application which had been downloaded to the cable box. In such a case the entire shopping episode could be conducted with a remote control and billed through the Cable Company. By having the BB resident, the problem of the phone line being busy when a home shopping viewer wishes to order, is eliminated. The order is communicated automatically by the BB application in the cable box. The Cable Company would be able to generate additional revenue for itself because it could then target advertiser's to its local customers much more accurately.

With another application of the BB/VSMS technology, similar Interactive Media Site catalogs on BBs can be inserted into set top boxes. Currently, many of the set top boxes have hard drive space. The BB VSMS software can be downloaded to the cable box by inserting a CD, DVD, or mini-disc media into existing slots within the cable box. This will provide local merchants a vehicle for selling their services and wares. AU the commercial spots that a Manufacturer or BB Merchant is airing locally could have commerce-enabling technology. Catalogs on a BB could be sent to the consumer on a monthly basis, along with their movie guide catalog.

The Cable Company could then generate revenues by (1) billing the consumer for the transaction or (2) charging a fee per downloaded BB store.

The foregoing descriptions of exemplary embodiments of the present disclosure have been presented for the purpose of illustration and description. It is not intended to be exhaustive nor to limit the inventive concepts to the embodiments disclosed. Many modifications and variations are possible in light of the above teaching. It is intended that the scope of the invention be limited not within this detailed description, but rather by the claims appended hereto, which appear below.

1. A method for providing an electronically virtualized server operating an IMS (Integrated Media Site) on a host device, the method comprising:
providing a mass storage media on which the electronically virtualized server, software is stored and from which the Integrated Media Site (IMS-BB) can be loaded on a host device, wherein said electronically virtualized, Integrated Media Site (IMS-BB) software includes software code for:
electronically virtualizing a web browser (eX-Browser), on the host device, for receiving content from a electronically virtualized server (VSMS);
electronically virtualizing the web server (VSMS), on the computer, for providing HTML pages to the web browser and searchable content to a search engine; and
providing the search engine to search content on the electronically virtualized server (VSMS) and provide the results to the electronically virtualized web browser (eX-Browser).

2. A method as in claim 1 wherein said electronically virtualized, Integrated Media Site (IMS-BB) software further includes software code for:
providing an audio and video capability for playing files from the electronically virtualized server(VSMS).

3. A method as in claim 1 wherein said electronically virtualized, Integrated Media Site (IMS BB) software further comprises E-Commerce software code for generating purchasing orders.

4. A method as in claim 3 wherein said E-Commerce software code further contains software code for:
providing a product search capability;
providing a shopping cart construct to contain customer purchases prior to ordering;
providing credit card processing; and
providing an ordering facility for communicating completed orders to one or more merchants.

5. A method as in claim 4 wherein providing an ordering facility for communicating completed orders to one or more merchants comprises, providing a purchasing order to be sent via the Internet, providing a purchasing order to be sent via a cable modem, providing a purchasing order to be sent via a telephone line, providing a purchasing order to be sent via a digital subscriber line, providing a purchasing order to be sent via radio link, providing a purchasing order to be sent via fax or providing a purchasing order to be mailed.

6. A method as in claim 1 wherein electronically virtualizing the web server (VSMS), on the host device, in providing HTML pages to the web browser further comprises;
retrieving graphics files from the electronically virtualized server(VSMS); and
retrieving CGI commands from a second host device.

7. A method as in claim 1 the second host device is a web server computer system.

8. An article of manufacture comprising a mass storage media on which electronically virtualized, Integrated Media Site (IMS-BB) software is stored and from which the electronically virtualized, Integrated Media Site (IMS-BB) software can be loaded on a host device wherein said electronically virtualized, Integrated Media Site (IMS-BB) software includes software code for:
electronically virtualizing a web browser (eX-Browser), on the host device, for receiving content from a electronically virtualized server(VSMS);
electronically virtualizing the web server (VSMS), on the host device, for providing HTML pages to the web browser and searchable content to a search engine; and
providing the search engine to search content on the electronically virtualized server (VSMS) and provide the results to the electronically virtualized web browser (eX-Browser).

9. An article of manufacture as in claim 8 wherein said electronically virtualized, Integrated Media Site (IMS-BB) software further includes software code for:
providing the capability for playing audio and video files from the electronically virtualized server(VSMS).

10. An article of manufacture as in claim 8 wherein said electronically virtualized, Integrated Media Site (IMS-BB) software further includes E-Commerce software code for generating purchasing orders.

11. An article of manufacture as in claim 10 wherein said E-Commerce engine includes software code for:
providing a product search capability;
providing a shopping cart construct to intermediately contain customer purchases prior to ordering;
providing payment processing; and
providing an ordering facility for communicating completed orders to one or more merchants.

12. An article of manufacture as in claim 11 wherein providing an ordering facility for communicating completed orders to one or more merchants comprises, providing a purchasing order to be sent via the Internet, providing a purchasing order to be sent via a cable modem, providing a purchasing order to be sent via a telephone line, providing a purchasing order to be sent via a digital subscriber line, providing a purchasing order to be sent via radio link, providing a purchasing order to be sent via fax or providing a purchasing order to be mailed.

13. A method of placing an order for one or more items comprising: displaying information identifying the one or more items on a user's display, said information stored within a local first mass storage;
receiving a request from a user to purchase one or more items;
receiving order information into a display's onscreen order form, wherein the program and data to receive information into the display's onscreen order form is stored in a second local mass storage;
generating a purchase order for one or more items using the information identifying the item and the information received by the onscreen order form; and immediately
opening up an Internet communication link from the 1^{st} host device, immediately ordering the one or more items using the purchase order.
ordering, at a later time, the one or more items using the purchase order.

14. The method of claim 13 wherein the local first mass storage is the same as the second local mass storage.

15. A method as in claim 14 wherein the first and second local mass storage units comprise a local hard disk.

16. A method as in claim 13 wherein the request to purchase each item is a single action.

17. A method as in claim 16 wherein the single action is clicking a confirmation prompt.

18. A method as in claim 13 further comprising placing information identifying the item into a shopping cart model.

19. A method as in claim 13 wherein ordering at a time later further comprises placing an order at a time determined by the user wherein the order is placed at the determined time without action by the user during the determined time.

20. A method as in claim 19 wherein ordering is ordering via the Internet.

21. A method as in claim 19 wherein ordering is via a modem and dial up telephone number.

22. A method as in claim 19 wherein the ordering is ordering via e-mail.

23. A method as in claim 13 wherein the ordering at a later date comprises producing an order on paper and mailing it, wherein the order is received at a later time.

24. A method as in claim 13 wherein the ordering at a later time further comprises sending more than one order to more than one destination.

25. A method as in claim 13 wherein the displaying information identifying one or more items further comprises:
retrieving a search mechanism which is stored locally;
inputting search criteria into said search mechanism; and
retrieving items consistent to the search criteria.

26. A method as in claim 25 wherein retrieving items consistent to the search criteria further comprises:
retrieving data from a local nonvolatile mass storage device;
displaying said data to the user.

27. A method as in claim 26 wherein the displaying said data to a user comprises displaying a graphic file to the user.

28. A method as in claim 26 wherein displaying said data further comprises displaying data in a video format.

29. A method as in claim 28 wherein the displaying said data further comprises displaying video data and accompanying sound.

30. A method as in claim 28 wherein displaying video data further comprises:
retrieving a video player program stored locally;
retrieving video data stored locally; and
playing said video data.

31. A method as in claim 30 wherein playing said video data comprises:
displaying video data, said video data being stored locally; and
providing sound accompanying said displayed video data, said sound data being stored locally.

32. An article of manufacture, said article of manufacture comprising:
a mass storage medium; and
a program disposed therein mass storage media, said program containing one or more programs for:
displaying information identifying the one or more items, said information stored within a local first mass storage;
receiving a request from a user to purchase one or more items;
receiving order information into an onscreen order form, wherein the program and data to receive information into the onscreen order form is stored in the second local mass storage;
generating a purchase order for one or more items using the information identifying the item and the information received by the onscreen order form; and
ordering, at a later time, the one or more items using the purchase order.

33. An article of manufacture as in claim 32 wherein the mass storage media is optically readable mass storage media.

34. An article of manufacture as in claim 19 wherein the mass storage media is magnetic storage media.

35. An article of manufacture wherein the mass storage media is a semiconductor device.

36. An article of manufacture as in claim 19 wherein said program contains all elements necessary to produce an E-Commerce shopping experience without obtaining data from any secondary source.

37. A method for providing profile information on a host device, the method comprising:
providing an interactive media site;
recording and storing user inputs to the interactive media site;
computing a user statistic based on the user inputs to the interactive media site; and
storing the statistic on a non-volatile storage device on the host device.

38. A method as in claim 37 wherein the computing of a user statistic may comprise computing how long a user remains on a particular Interactive Media Site page, computing how many times a user visits a particular interactive media site page or computing how many times a user traverses a particular interactive media site page

39. A method as in claim 37 wherein non-volatile storage device on the host device comprises a hard disk.

40. A method for updating an interactive media site on a host device, the method comprising:
receiving update data from an external server using a background task;
accumulating the update data within the host device;
providing access to the additional data within the host device only when all of the additional data is resident and usable on the host device.

41. A method as in claim 40 wherein receiving update data from an external server comprises receiving data coupled into a cable modem, wireless device, telephone modem or digital subscriber line by the external server.

42. A method as in claim 40 wherein accumulating the update data within the host device comprises storing the update data in RAM (Random Access Memory) within the host device.

43. A method as in claim 40 wherein providing access to the additional data within the host device only when all of the additional data is resident and usable on the host device comprises providing clickable links in the interactive media site which access the additional data.

44. A method as in claim 40 wherein providing access to the additional data within the host device only when all of the additional data is resident and usable on the host device comprises providing at least one pop up display in the interactive media site comprising the additional data.

45. A method as in claim 40 wherein providing access to the additional data within the host device only when all of the additional data is resident and usable on the host device further comprises; and
providing at least one additional display item, comprising additional data, on at least one interactive media page site.

46. A method for targeting user's attention on an interactive media site on a host device, the method comprising:
computing a local profile within the host device;
transmitting the local profile to an external server;
analyzing the profile;
selecting an advertisement, product, or service based on the local profile;
transmitting the advertisement, product, or service to the host device;
receiving the advertisement, product, or service using a background task in the host device; and
providing the advertisement, product, or service to a user of the host device when the entire advertisement, product, or service has been received into the host device.

47. A method as in claim 46 wherein computing a local profile within the host device further comprises:
providing an interactive media site;
recording and storing user inputs to the interactive media site; and
computing a user statistic based on the user inputs to the interactive media site.

48. A method as in claim 46 wherein transmitting the local profile to an external server further comprises:
coupling the local profile into a background task; and
transmitting the local profile to the external server using the background task.

49. A method as in claim 46 wherein providing the advertisement, product, or service to a user of the host device further comprises providing a pop up advertisement, product, or service.

50. A method as in claim 46 wherein providing the advertisement, product, or service to a user of the host device further comprises providing a pop up advertisement, product, or service when a user accesses a page on the interactive media site related to the local profile.

51. A method as in claim 46 wherein providing the advertisement, product, or service to a user of the host device further comprises providing at least one new entry on an interactive media site page related to the local profile.

52. A method as in claim 46 wherein transmitting the local profile to an external server further comprises:
coupling the local profile into a background task; and
transmitting the local profile to the external server using the background task.

54. A method for providing a user's shopping and viewing profile on an Interactive Media Site displayed on a host device, the method comprising:
monitoring user inputs, at the host device, to the interactive media site;
computing a user statistic from the user inputs to the interactive media site; and
displaying the user statistic on the host device.

55. A method as in claim 54 wherein monitoring user inputs, at the host device, to the interactive media site comprises recording how often each interactive media site page was accessed by the user.

56. A method as in claim 54 wherein monitoring user inputs, at the host device, to the interactive media site comprises recording how long each interactive media site page was displayed by the user.

57. A method as in claim 55 wherein displaying the user statistic on the host device further comprises arranging links to interactive media sites according to how often each interactive media site page was accessed by the user.

58. A method as in claim 56 wherein displaying the user statistic on the host device further comprises arranging links to interactive media sites according to how long each interactive media site page was displayed by the user.

59. A method for generating income by providing targeted advertising on a host device displaying an interactive media site the method comprising:
profiling, on the host device user preferences in accessing the interactive media site;
transmitting the user's profile to a remote server;
receiving a targeted advertisement, product, or service, said advertisement, product, or service selected using said users profile, from the remote server;
providing the targeted advertisement, product, or service to a user when the complete advertisement, product, or service has been received by the user; and
charging a fee for the targeted ad.

60. A method as in claim 59 wherein providing the user's profile to a remote server further comprises:
retrieving a user profile from a non volatile storage on the host device;
providing the user profile to a background task within the host device; and
transmitting the profile using the background task.

61. A method for generating income by providing a targeted advertisement, product, or service for an interactive media site displayed on a host device, the method comprising:
receiving a profile comprising a user's preference in accessing the interactive media site;
selecting an advertisement, product, or service using the received profile;
transmitting the targeted advertisement, product, or service, to be provided to the user of the interactive media site when it has been received in it's entirety, to the host device; and
charging a fee for the targeted ad.

62. A method as in claim 61 wherein selecting an advertisement, product, or service using the received profile further comprises:
determining how long a user has spent displaying each page; and
targeting advertisements, products, services based on page display time.

63. A method as in claim 61 wherein selecting an advertisement, product, or service using the received profile further comprises:
determining how often a user has displaying each page; and
targeting advertisements, products, services based on the number of page displays.

64. A method as in claim 61 wherein selecting an advertisement, product, or service using the received profile further comprises:
determining how often a user has clicked on an item thereby seeking additional information about the item; and
targeting advertisements, products, services based on the number of item clicks.

65. A method of placing an order for an item displayed on an interactive media site, the method comprising:
under the control of a host device:
displaying information identifying the item on the interactive media site, in response to a single action being performed creating a purchasing order which is sent to a merchant via fax, ordinary mail, wireless interface, local link, telephone modem, cable modem, or a digital subscriber line (DSL).

66. The method of claim 65 wherein the displaying of information includes displaying information indicating the single action.

67. The method of claim 65 wherein the single action is clicking a button.

68. The method of claim 65 wherein the client ordering information is contained within a non-volatile storage on the host device.
